(19) United States
(12) Patent Application Publication
(10) Pub. No.: US 2014/0092285 A1
(43) Pub. Date: Apr. 3, 2014

(54) SOLID-STATE IMAGING DEVICE, METHOD FOR DRIVING THE SAME, AND ELECTRONIC DEVICE

(71) Applicant: Sony Corporation, Tokyo (JP)

(72) Inventors: Yusuke Moriyama, Kanagawa (JP); Tomohiro Takahashi, Kanagawa (JP)

(73) Assignee: Sony Corporation, Tokyo (JP)

(21) Appl. No.: 14/025,486

(22) Filed: Sep. 12, 2013

(30) Foreign Application Priority Data
Sep. 28, 2012 (JP) 2012-218301

(51) Int. Cl. H04N 5/235; H04N 5/374

(52) U.S. Cl. CPC H04N 5/235; H04N 5/374
USPC 348/297

(57) ABSTRACT

A solid-state imaging device and method of driving a pixel array section are described herein. By way of example, the solid-state imaging device includes a pixel array section including a sharing pixel block, the sharing pixel block including a plurality of pixels, each of the plurality of pixels including a photoelectric conversion region, and each of the plurality of pixels of the sharing pixel block sharing a floating diffusion region, and a driver section configured to drive the pixel array section such that electric charges accumulated in one or more but less than all of the photoelectric conversion regions of the sharing pixel block undergo pixel addition and are read out.

### BACKGROUND

The present disclosure relates to a solid-state imaging device, a method for driving the solid-state imaging device, and an electronic device, and more particularly, relates to a solid-state imaging device, a method for driving the solid-state imaging device, and an electronic device which allow photographing to be performed with more suitable sensitivity to light.

To date, in imaging devices including an imaging sensor, in order to photograph a smooth moving image, usually, the accumulation time has been increased. Also, in order to photograph an image with a shallow depth of field, an F value of a lens has been reduced (the aperture has been opened).

However, when the accumulation time is increased or the F value of the lens is reduced, there might be cases where the amount of electric charge accumulated in a photodiode of a solid-state imaging device reaches a saturation amount of electric charge. Thus, a neutral density (ND) filter used for adjusting the amount of light is attached to a lens to reduce the amount of light incident on a solid-state imaging device so that the amount of electric charge accumulated in a photodiode does not reach the saturation amount of electric charge.

However, a user is inconvenienced in several ways. For example, the user has to prepare an ND filter with a size corresponding to a lens diameter, the user has to stop photographing when attaching/removing the ND filter to/from the lens, and the like.

For such inconveniences, a solid-state imaging device in which a single pixel is divided into a plurality of divided pixels and sensitivity or an accumulation time is changed for each divided pixel such that different pixel signals are read out from the divided pixels has been proposed (see, for example, Japanese Unexamined Patent Application Publication No. 2010-28423). Thus, similar to the case where an ND filter is used, even when no ND filter is used, photographing with low sensitivity may be performed.

However, in a technology according to Japanese Unexamined Patent Application Publication No. 2010-28423, pixel signals are read out from each of divided pixels obtained by dividing a single pixel, and thus, the sensitivity of each individual divided pixel is reduced. Therefore, the technology is not suitable for photographing in a dark place.

In view of the above-described points, the present technology has been devised to enable photographing with more suitable sensitivity.

### SUMMARY

A solid-state imaging device and method of driving a pixel array section are described herein. By way of example, the solid-state imaging device includes a pixel array section including a sharing pixel block, the sharing pixel block including a plurality of pixels, each of the plurality of pixels including a photoelectric conversion region, and each of the plurality of pixels of the sharing pixel block sharing a floating diffusion region, and a driver section configured to drive the pixel array section such that electric charges accumulated in one or more but less than all of the photoelectric conversion regions of the sharing pixel block undergo pixel addition and are read out.

By way of a second example, in the method of driving a pixel array section, the pixel array section includes a sharing pixel block, the sharing pixel block includes a plurality of pixels, each of the plurality of pixels includes a photoelectric conversion region, and each of the plurality of pixels of the shares a pixel block sharing a floating diffusion region. The method of driving a pixel array section includes driving the pixel array section such that electric charges accumulated in one or more but less than all of the photoelectric conversion regions of the sharing pixel block undergo pixel addition and are read out.

### BRIEF DESCRIPTION OF THE DRAWINGS

FIG. 1 is a block diagram illustrating a configuration example of a solid-state imaging device to which the present technology is applied;

FIG. 2 is a block diagram illustrating a more detailed configuration example of the solid-state imaging device;

FIG. 3 is a table illustrating the relationship between outputs of a latch circuits and drive signals of a driver;

FIG. 4 is a table illustrating the relationship between the number of pixels to be driven and the number of added pixels;

FIG. 5 is a diagram illustrating patterns of pixels to be added;

FIG. 6 is a diagram illustrating a configuration example of a sharing pixel block;

FIG. 7 is a timing chart illustrating an example of pixel driving;

FIG. 8 is a timing chart illustrating an example of pixel driving;

FIG. 9 is a timing chart illustrating an example of pixel driving;

FIG. 10 is a timing chart illustrating an example of pixel driving;

FIG. 11 is a chart illustrating the relationship between accumulation time and signal amount;

FIG. 12 is a chart illustrating the relationship between accumulation time and signal amount;

FIG. 13 is a chart illustrating the relationship between lens F value and signal amount;

FIG. 14 is a chart describing achieving of a wide dynamic range;

FIG. 15 is a timing chart illustrating an example of pixel driving;

FIG. 16 is a timing chart illustrating an example of pixel driving;

FIG. 17 is a timing chart illustrating an example of pixel driving;

FIG. 18 is a timing chart illustrating an example of pixel driving;

FIG. 19 is a block diagram illustrating another configuration example of the solid-state imaging device;

FIG. 20 is a diagram illustrating another configuration example of a sharing pixel block;

FIG. 21 is a diagram illustrating still another configuration example of a sharing pixel block;

FIG. 22 is a timing chart illustrating an example of pixel driving;

FIG. 23 is a timing chart illustrating an example of pixel driving;

FIG. 24 is a timing chart illustrating an example of pixel driving;

FIG. 25 is a timing chart illustrating an example of pixel driving;

FIG. 26 is a chart describing achieving of a wide dynamic range;

FIG. 27 is a timing chart illustrating an example of pixel driving;

FIG. 28 is a timing chart illustrating an example of pixel driving;

FIG. 29 is a timing chart illustrating an example of pixel driving;

FIG. 30 is a timing chart illustrating an example of pixel driving;

FIG. 31 is a diagram illustrating an example arrangement of color filters; and

FIG. 32 is a block diagram illustrating a configuration example of an electronic device according to an embodiment to which the present technology is applied.

### DETAILED DESCRIPTION OF EMBODIMENTS

Embodiments of the present technology will be hereinafter described with reference to the accompanying drawings.

### Configuration of Solid-State Imaging Device

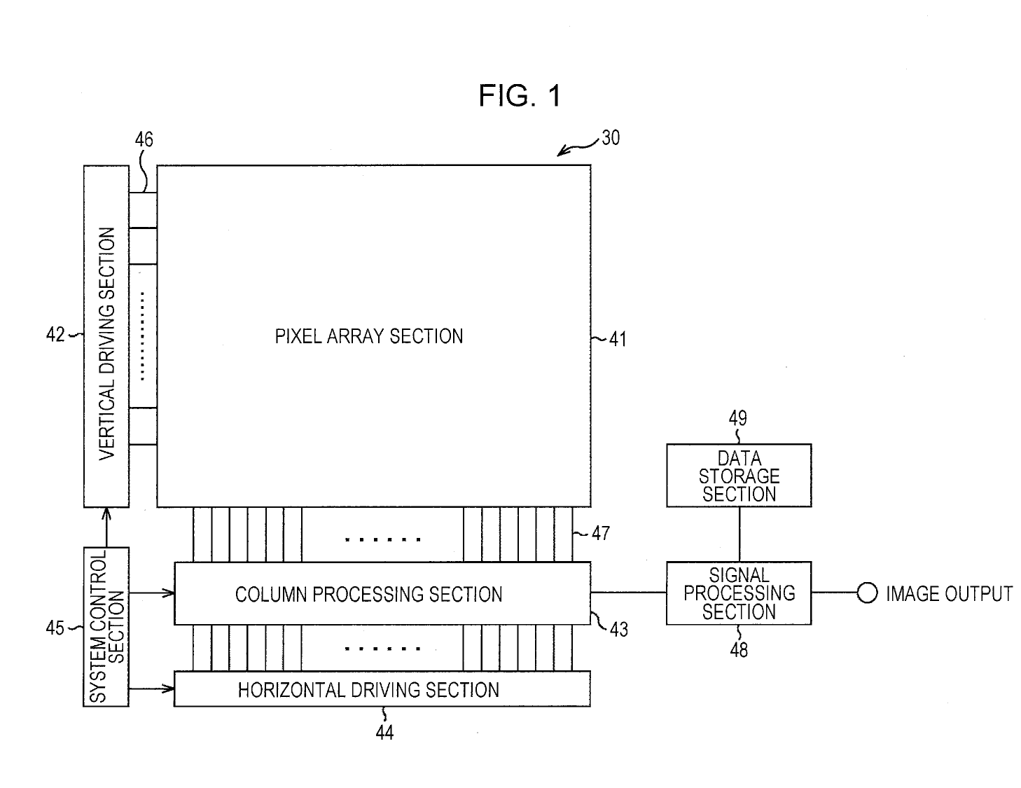

FIG. 1 is a block diagram illustrating a configuration example of a complementary metal oxide semiconductor (CMOS) image sensor as a solid-state imaging device to which the present technology is applied.

A CMOS image sensor 30 includes a pixel array section 41, a vertical driving section 42, a column processing section 43, a horizontal driving section 44, and a system control section 45. The pixel array section 41, the vertical driving section 42, the column processing section 43, the horizontal driving section 44, and the system control section 45 are formed on a semiconductor substrate (chip), which is not illustrated in FIG. 1.

In the pixel array section 41, pixels each including a photoelectric conversion element that generates photocharge of an electric charge amount corresponding to an incident light amount and accumulates the generated photocharge therein are two-dimensionally arranged in a matrix. Note that the photocharge of an electric charge amount corresponding to an incident light amount might be merely referred to as “electric charge” hereinafter.

Furthermore, in the pixel array section 41, a pixel driving line 46 is formed for each row of the matrix pixel arrangement so as to extend in the left-right direction of FIG. 1 (along a direction in which pixels of each pixel row are arranged), and a vertical signal line 47 is formed for each column of the matrix pixel arrangement so as to extend in the top-bottom direction of FIG. 1 (along a direction in which pixels of each pixel column are arranged). One end of the pixel driving line 46 is connected to a corresponding one of output terminals of the vertical driving section 42 which are provided so as to correspond to pixel rows.

The CMOS image sensor 30 further includes a signal processing section 48 and a data storage section 49. The signal processing section 48 and the data storage section 49 may be mounted, for example, as a digital signal processor (DSP) circuit, on a different substrate from the substrate on which the CMOS image sensor 30 is mounted, or may be mounted on the same substrate as the CMOS image sensor 30 is mounted.

The vertical driving section 42 includes a decoder and a driver and serves as a pixel driving section that drives pixels of the pixel array section 41 all at a time or in units of rows. The vertical driving section 42, a specific configuration of which will be described later, is configured to have a read-scanning system and a sweep-scanning system, or a function of collective sweep and collective transfer.

In order to read signals from pixels, the read-scanning system performs selective scanning sequentially on the pixels of the pixel array section 41 in units of rows. As for sweeping, in the case of row driving (rolling shutter operation), the sweep-scanning is performed on a read row for which read scanning is to be performed by the read-scanning system earlier than the time of the read scanning by a time corresponding to the shutter speed. In the case of global exposure (global shutter operation), collective sweeping is performed earlier than the time of collective transfer by a time corresponding to shutter speed.

By this sweeping, unnecessary electric charge is swept (reset) from the photoelectric conversion elements of the pixels in the read row. By the sweeping (resetting) of the unnecessary electric charge, a so-called shutter operation is performed. Shutter operation herein refers to an operation of discharging the photocharge of the photoelectric conversion element and newly starting exposure (starting accumulating of photocharge).

The signal read out by the reading operation of the read-scanning system corresponds to the amount of light that has entered after a previous reading operation immediately before the reading operation or the shutter operation. In the case of row driving, the period from a read timing of the previous reading operation or a sweep timing of the shutter operation to a read timing of the current reading operation is the accumulation time (exposure time) of the photocharge in the pixels. In the case of global exposure, the period from collective sweep to collective transfer is the accumulation time (exposure time).

A pixel signal output from each of the pixels in the pixel row selectively scanned by the vertical driving section 42 is supplied to the column processing section 43 via a corresponding one of the vertical signal lines 47. For each pixel column of the pixel array section 41, the column processing section 43 performs predetermined signal processing on the pixel signal output from each of the pixels in the selected row via a corresponding one of the vertical signal lines 47 and temporarily holds the pixel signal which has undergone signal processing. Note that the column processing section 43 may be configured to have an analog-digital (A/D) conversion function of outputting a signal level as a digital signal.

The horizontal driving section 44 includes a shift register and an address decoder and sequentially selects unit circuits corresponding to pixel columns of the column processing section 43. By this selective scanning by the horizontal driving section 44, pixel signals processed by the column processing section 43 are sequentially output to the signal processing section 48.

The system control section 45 includes a timing generator that generates various timing signals, and the like, and performs driving control of the vertical driving section 42, the column processing section 43, and the horizontal driving section 44 on the basis of the various timing signals generated by the timing generator, thereby controlling driving of pixels.

The signal processing section 48 has at least an addition processing function, and performs various types of signal processing such as addition processing and the like on the pixel signals output from the column processing section 43. For signal processing performed in the signal processing section 48, the data storage section 49 temporarily accumulates data necessary for the processing.

### Detailed Configuration Example of Solid-State Imaging Device

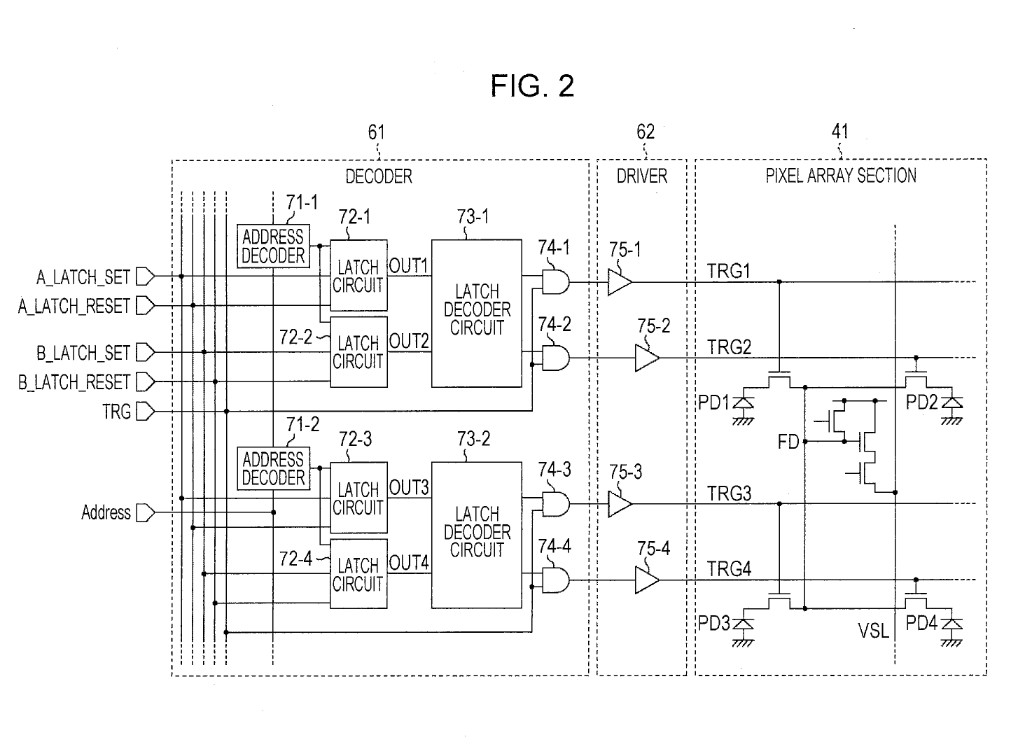

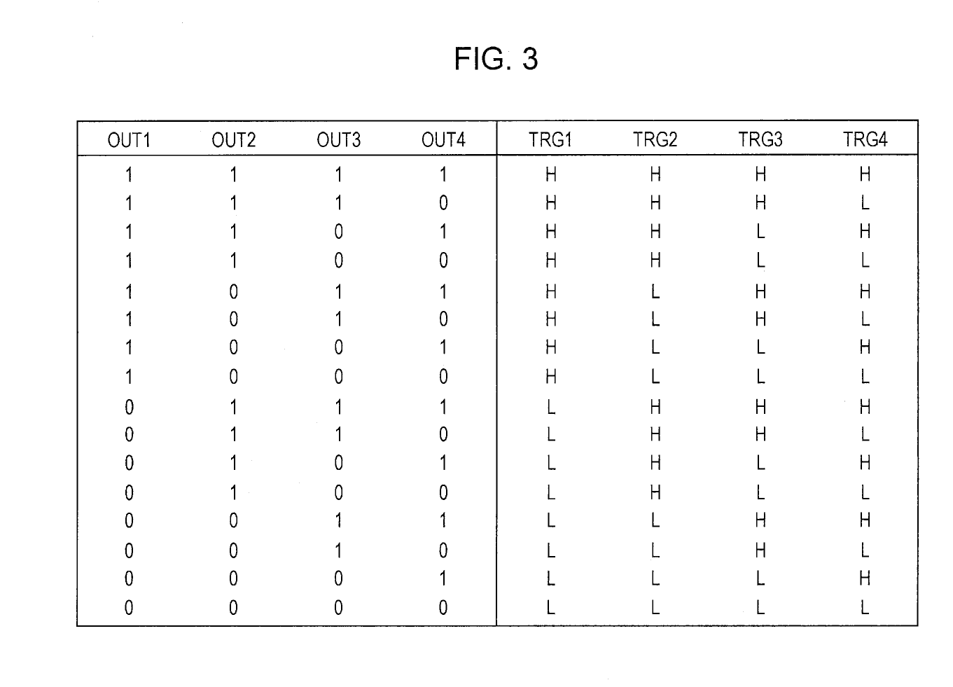

Next, with reference to FIG. 2 and FIG. 3, a configuration example of the decoder and the driver constituting the vertical driving section 42 of FIG. 1 and pixels arranged in a matrix in the pixel array section 41 will be described.

First, as illustrated in FIG. 2, the pixels are arranged in a matrix in the pixel array section 41 such that four pixels (PD1 to PD4) arranged in two columns and two rows share a single electric charge voltage conversion section (so-called floating diffusion, which will be hereinafter referred to as “FD”). That is, the pixels PD1 to PD4 undergo pixel addition (FD addition). A block of pixels sharing a signal FD will be hereinafter referred to as a “sharing pixel block” and a circuit configuration thereof will be described later with reference to FIG. 3.

A decoder 61 and a driver 62 illustrated in FIG. 2 constitute the vertical driving section 42 of FIG. 1.

The decoder 61 includes address decoders 71-1 and 71-2, latch circuits 72-1 to 72-4, latch decoder circuits 73-1 and 73-2, and AND gates 74-1 and 74-2. Also, the driver 62 includes driver circuits 75-1 to 75-4. Note that, when the address decoders 71-1 and 71-2, the latch circuits 72-1 to 72-4, the latch decoder circuits 73-1 and 73-2, the AND gates 74-1 and 74-2, and the driver circuits 75-1 to 75-4 do not have to be distinguished from one another, the address decoders 71-1 and 71-2, the latch circuits 72-1 to 72-4, the latch decoder circuits 73-1 and 73-2, the AND gates 74-1 and 74-2, and the driver circuits 75-1 to 75-4 will be hereinafter merely referred to as address decoders 71, latch circuits 72, latch decoder circuits 73, AND gates 74, and driver circuits 75, respectively.

In FIG. 2, the address decoder 71 and the latch decoder circuit 73 are provided for each pixel row, and the latch circuit 72, the AND gate 74, and the driver circuit 75 are provided for each of the pixels included in the pixel row.

The address decoder 71 selects, on the basis of a control signal Address from the system control section 45, a single, all, or some of the pixel rows as necessary.

The latch circuit 72 supplies, in accordance with a writing operation performed by the system control section 45, an output signal used for controlling an operation of the driver circuit 75 that drives the pixels in a pixel row selected by the address decoder 71 to the latch decoder circuits 73.

For example, each of the latch circuits 72-1 and 72-3 outputs, when A_LATCH_SET is written by the system control section 45, 1 as an output signal, and outputs, when A_LATCH_RESET is written, 0 as an output signal. Also, each of the latch circuits 72-2 and 72-4 outputs, when B_LATCH_SET is written by the system control section 45, 1 as an output signal, and outputs, when B_LATCH_RESET is written, 0 as an output signal.

The latch decoder circuit 73 performs decode processing on an output signal from the corresponding latch circuit 72 and supplies the output signal corresponding to the output signal from the corresponding latch circuit 72 to the corresponding AND gate 74.

On the basis of a driving signal TRG from the system control section 45 and the output signal from the corresponding latch decoder circuit 73, the AND gate 74 supplies an operation signal used for operating the corresponding driver circuit 75 to the driver circuit 75.

In response to the operation signal from the corresponding AND gate 74, the driver circuit 75 supplies to each pixel in the sharing pixel block of the pixel array section 41 a driving signal used for driving the pixel.

For example, when 1 is output as an output signal by the latch circuit 72 and an output signal corresponding to the output signal 1 from the latch circuit 72 is supplied to the corresponding AND gate 74 by the corresponding latch decoder circuit 73, the AND gate 74 causes the driving signal TRG from the system control section 45 to pass therethrough and the corresponding driver circuit 75 outputs a high (H) level drive signal. When 0 is output as an output signal by the latch circuit 72 and an output signal corresponding to the output signal 0 from the latch circuits 72 is supplied to the corresponding AND gate 74 by the corresponding latch decoder circuit 73, the AND gate 74 does not cause the drive signal TRG from the system control section 45 to pass therethrough and the corresponding driver circuit 75 outputs a low (L) level drive signal.

That is, as illustrated in FIG. 3, drive signals TRG1 to TRG4 output by the driver circuits 75-1 to 75-4 are controlled by output signals OUT1 to OUT4 of the latch circuits 72-1 to 72-4.

Specifically, for example, when the output signals OUT1 to OUT4 of the latch circuits 72-1 to 72-4 are 1, 1, 1, and 1, respectively, the drive signals TRG1 to TRG4 output by the driver circuits 75-1 to 75-4 are H, H, H, and H, respectively. Also, for example, when the output signals OUT1 to OUT4 of the latch circuits 72-1 to 72-4 are 1, 0, 1, and 0, respectively, the drive signals TRG1 to TRG4 output by the driver circuits 75-1 to 75-4 are H, L, H, and L, respectively.

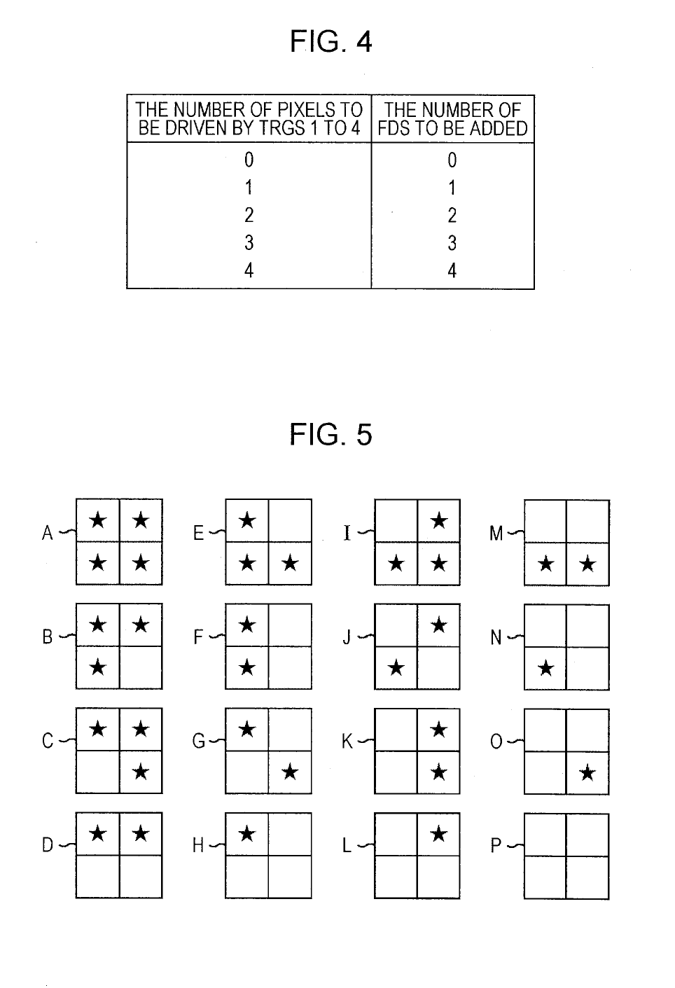

Thus, in accordance with results of writing operations to the latch circuits 72-1 to 72-4, driving of the driver circuits 75-1 to 75-4 is controlled. As a result, as illustrated in FIG. 4, the number of pixels to be driven among the pixels PD1 to PD4 in the sharing pixel block is controlled, and the number of pixels to be added (the number of FDs to be added) in the sharing pixel block of the pixel array section 41 is determined.

That is, when the number of pixels to be driven in the sharing pixel block is 0, the number of pixels to be added in the sharing pixel block is 0, and, when the number of pixels to be driven in the sharing pixel block is 1, the number of pixels to be added in the sharing pixel block is 1. Also, when the number of pixels to be driven in the sharing pixel block is 2, the number of pixels to be added in the sharing pixel block is 2, and when the number of pixels to be driven in the sharing pixel block is 3, the number of pixels to be added in the sharing pixel block is 3. Furthermore, when the number of pixels to be driven in the sharing pixel block is 4, the number of pixels to be added in the sharing pixel block is 4.

Note that, as illustrated in FIG. 5, there are 16 patterns A to P for the pixels in the sharing pixel block which are to undergo pixel addition. For example, A in FIG. 5 indicate a case where all of the pixels PD1 to PD4 in the sharing pixel block undergo pixel addition (four-pixel addition), and B in FIG. 5 indicates a case where the pixels PD1 to PD3 among the pixels PD1 to PD4 in the sharing pixel block undergo pixel addition (three-pixel addition). Also, K in FIG. 5 indicates a case where the pixels PD2 and PD4 among the pixels PD1 to PD4 in the sharing pixel block undergo pixel addition (two-pixel addition), and N in FIG. 5 indicates a case where the pixel PD3 among the pixels PD1 to PD4 in the sharing pixel block undergoes pixel addition (one-pixel addition).

Thus, driving of a predetermined pixel in the sharing pixel block in which pixels share the FD 93 is controlled.

Note that, in the configuration of FIG. 2, the latch circuit 72 and the driver circuit 75 are provided so as to correspond to each other, and thus, the latch decoder circuit 73 may be omitted. By providing, when a single pixel row includes pixels that perform the same driving, the latch decoder circuits 73, the number of the latch circuits 72 relative to the driver circuits 75 may be reduced. That is, with the latch decoder circuits 73 provided, a single latch circuit 72 may be provided relative to pixels that perform the same driving in a single pixel row, and the latch circuit 72 does not have to be provided for each pixel. Thus, the circuit size may be reduced.

### Circuit Configuration Example of Sharing Pixel Block

Next, a circuit configuration example of the sharing pixel block arranged in the pixel array section 41 will be described.

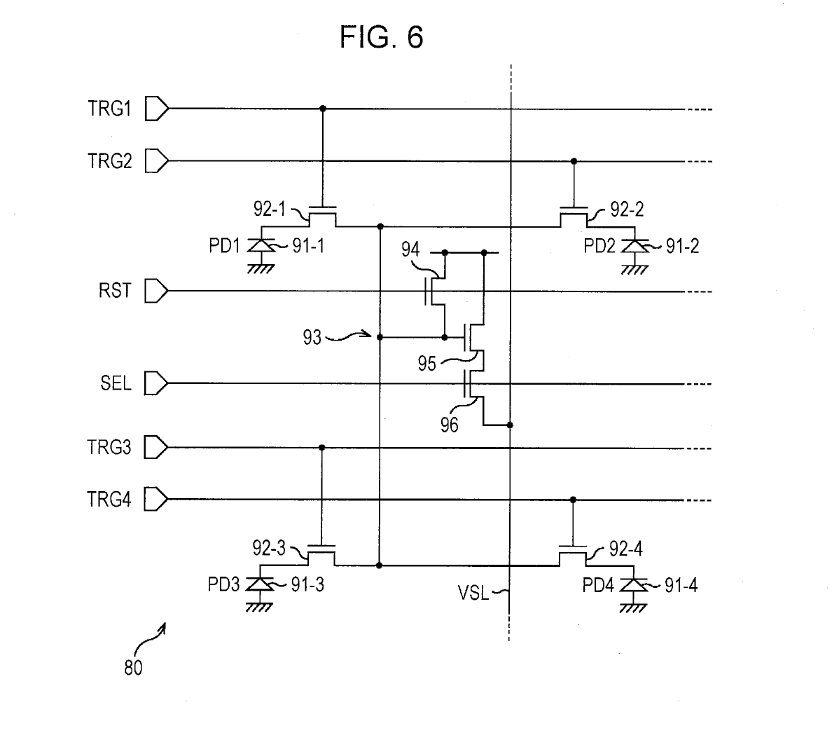

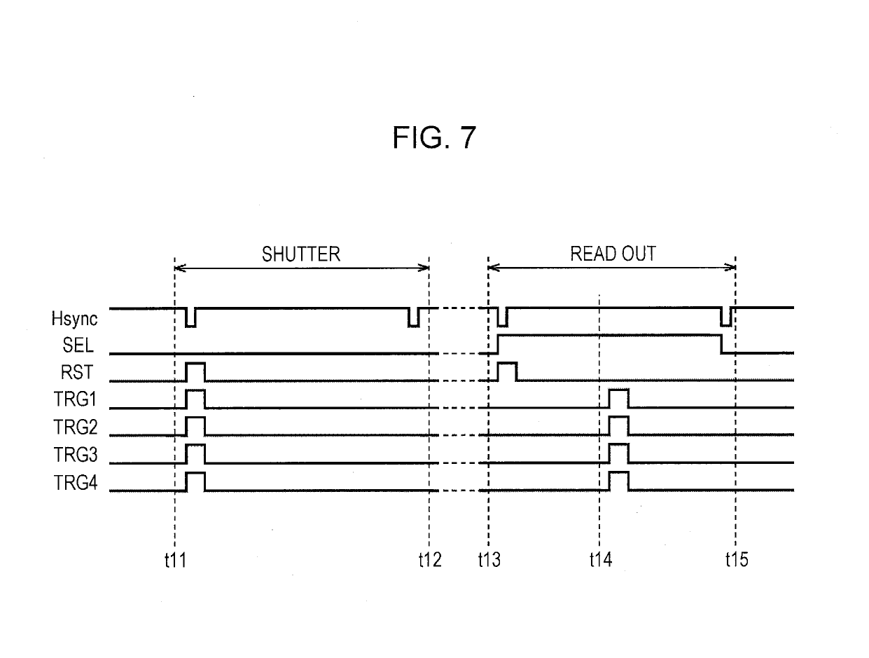

A sharing pixel block 80 of FIG. 6 includes photodiodes 91-1 to 91-4 (PD1 to PD4), transfer gates 92-1 to 92-4, an FD 93, a reset transistor 94, an amplifying transistor 95, a selection transistor 96, and a vertical signal line VSL.

Anodes of the photodiodes 91-1 to 91-4 are grounded, and each of cathodes of photodiodes 91-1 to 91-4 is connected to a corresponding one of sources of the transfer gates 92-1 to 92-4. Each of drains of the transfer gates 92-1 to 92-4 is connected to a drain of the reset transistor 94 and a gate of the amplifying transistor 95, and the connection point serves as the FD 93 which serves as an electric charge voltage conversion section.

A source of the reset transistor 94 and a source of the amplifying transistor 95 are connected to a predetermined power source (not illustrated). A drain of the amplifying transistor 95 is connected to a source of the selection transistor 96, and a drain of the selection transistor 96 is connected to the vertical signal line VSL. The vertical signal line VSL is connected to a constant current source of a source follower circuit (not illustrated).

Each of gates of the transfer gates 92-1 to 92-4, a gate of the reset transistor 94, and a gate of the selection transistor 96 are connected to the vertical driving section 42 of FIG. 1, and a pulse as a drive signal is supplied to each of the gates.

A function of each component of the sharing pixel block 80 will be hereinafter described.

Each of the photodiodes 91-1 to 91-4 photoelectric-converts incident light, generates electric charge corresponding to the amount of the incident light, and accumulates the electric charge.

Each of the transfer gates 92-1 to 92-4 switches on and off transfer of the electric charge to the FD 93 from a corresponding one of the photodiodes 91-1 to 91-4 in accordance with a corresponding one of the drive signals TRG1 to TRG4 supplied from the vertical driving section 42 (the driver circuits 75-1 to 75-4). For example, when the H level drive signals TRG1 to TRG4 are supplied, each of the transfer gates 92-1 to 92-4 transfers the electric charge accumulated in a corresponding one of the photodiodes 91-1 to 91-4 to the FD 93 and, when the L level drive signals TRG1 to TRG4 are supplied, each of the transfer gates 92-1 to 92-4 stops transfer of the electric charge. Note that, while the transfer gates 92-1 to 92-4 stop transfer of the electric charge to the FD 93, the electric charge obtained by photoelectric conversion by the photodiodes 91-1 to 91-4 is accumulated in the photodiodes 91-1 to 91-4.

The FD 93 accumulates the electric charge transferred from the photodiodes 91-1 to 91-4 via the transfer gates 92-1 to 92-4 and converts the electric charge into a voltage.

The reset transistor 94 switches on and off discharge of the electric charge accumulated in the FD 93 in accordance with a drive signal RST supplied from the vertical driving section 42. For example, when the H level drive signal RST is supplied, the reset transistor 94 clamps the FD 93 to a power supply voltage and discharges (resets) the electric charge accumulated in the FD 93. On the other hand, when the L level drive signal RST is supplied, the reset transistor 94 puts the FD 93 into an electrically floating state.

The amplifying transistor 95 amplifies a voltage corresponding to the electric charge accumulated in the FD 93. The voltage (voltage signal) amplified by the amplifying transistor 95 is output to the vertical signal line VSL via the selection transistor 96.

The selection transistor 96 switches on and off output of a voltage signal from the amplifying transistor 95 to the vertical signal line VSL in accordance with a drive signal SEL supplied from the vertical driving section 42. For example, the selection transistor 96 outputs, when the H level drive signal SEL is supplied, the voltage signal to the vertical signal line VSL and stops, when the L level drive signal SEL is supplied, output of the voltage signal.

Thus, each pixel of the sharing pixel block 80 is driven in accordance with the drive signals TRG1 to TRG4, the drive signal RST, and the drive signal SEL which are supplied from the vertical driving section 42.

### Example of Driving of Pixels (Four-Pixel Addition)

Next, with reference to a timing chart of FIG. 7, an example of driving each pixel in the sharing pixel block 80 when four-pixel addition is performed will be described.

In FIG. 7, “Hsync” represents a horizontal synchronization signal, and a cycle of the horizontal synchronization signal is a period in which pixel signals in a single row are output.

First, in the shutter period from the time t11 to the time t12, when the drive signals RST and TRG1 to TRG4 in pulses are applied, the electric charges accumulated in the photodiodes 91-1 to 91-4 and FD 93 are discharged.

Thus, the electric charges which have been accumulated in the photodiodes 91-1 to 91-4 by the time are swept and electric charge newly obtained from light from an object is accumulated in the photodiodes 91-1 to 91-4.

Next, in the read period from the time t13 to the time t15, first, the drive signal SEL is changed from the L level to the H level at the time t13, the drive signal RST in pulses is applied, and the electric charge accumulated in the FD 93 is discharged.

Thereafter, at the time t14, when the drive signals TRG1 to TRG4 in pulses are applied, the electric charges accumulated in the photodiodes 91-1 to 91-4 are transferred to the FD 93 by the transfer gates 92-1 to 92-4, respectively. Thus, a voltage corresponding to the electric charge of the four pixels transferred to the FD 93 is read out as a signal level.

Thus, all of the pixels PD1 to PD4 in the sharing pixel block undergo pixel addition.

### Example of Driving of Pixels (Three-Pixel Addition)

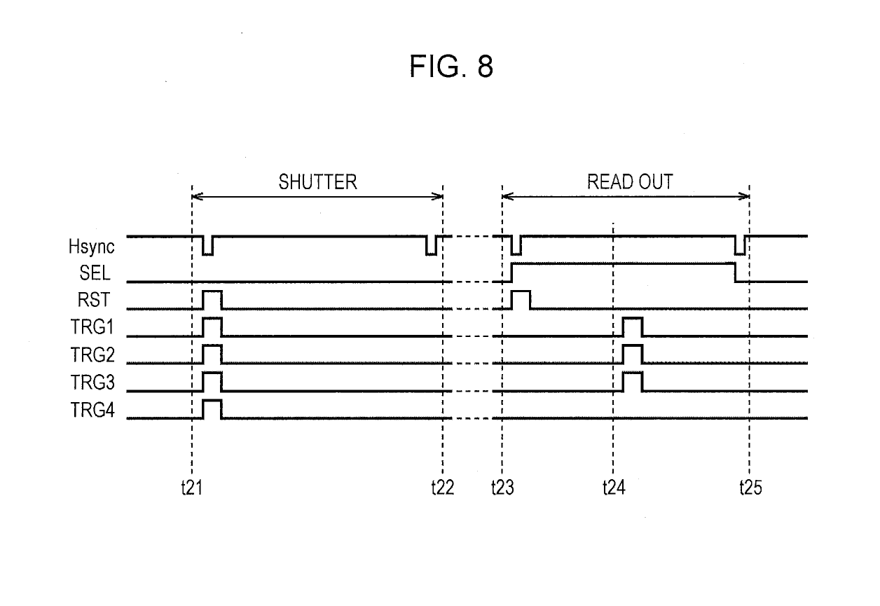

Next, with reference to a timing chart of FIG. 8, an example of driving each pixel in the sharing pixel block 80 when three-pixel addition is performed will be described.

Note that, in FIG. 8, an operation performed in the period from the time t21 to the time t24 is similar to the operation of FIG. 7 performed in the period from the time t11 to the time t14, and therefore, the description thereof will be omitted.

That is, at the time t24, when the drive signals TRG1 to TRG3 in pulses are applied, the electric charges accumulated in the photodiodes 91-1 to 91-3 are transferred to the FD 93 by the transfer gates 92-1 to 92-3, respectively. Thus, a voltage corresponding to the electric charge of the three pixels transferred to the FD 93 is read out as a signal level.

Thus, among the pixels PD1 to PD4 in the sharing pixel block, the pixels PD1 to PD3 undergo pixel addition.

### Example of Driving of Pixels (Two-Pixel Addition)

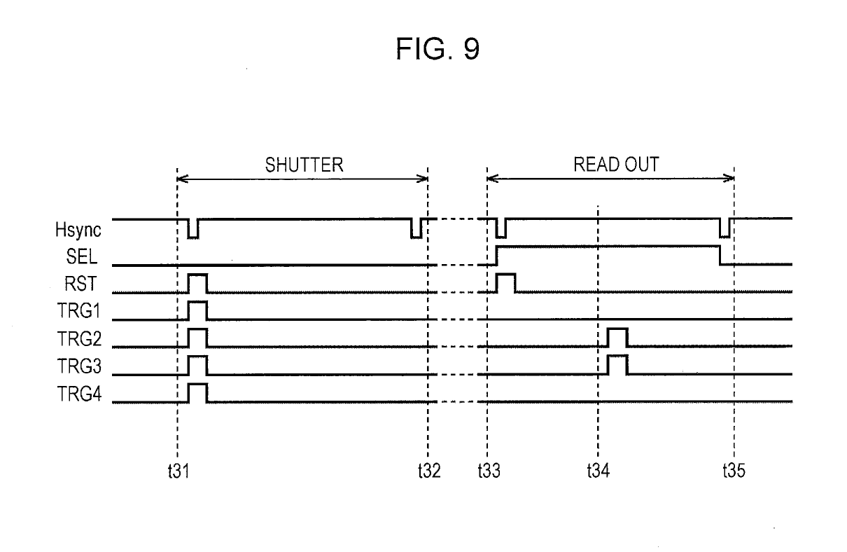

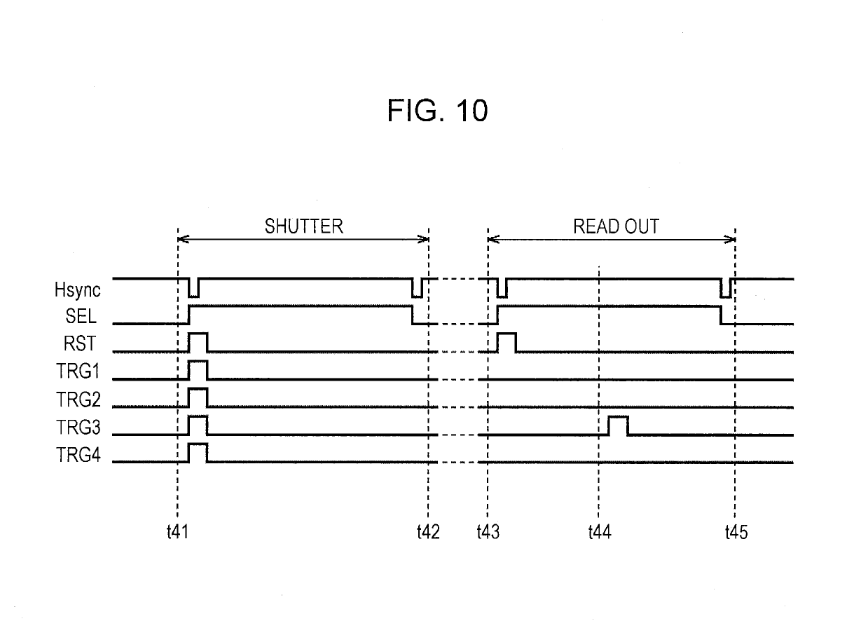

Next, with reference to a timing chart of FIG. 9, an example of driving each pixel in the sharing pixel block 80 when two-pixel addition is performed will be described.

Note that, in FIG. 9, an operation performed in the period from the time t31 to the time t34 is similar to the operation of FIG. 7 performed in the period from the time t11 to the time t14, and therefore, the description thereof will be omitted.

That is, at the time t34, when the drive signals TRG2 and TRG3 in pulses are applied, the electric charges accumulated in the photodiodes 91-2 to 91-3 are transferred to the FD 93 by the transfer gates 92-2 to 92-3, respectively. Thus, a voltage corresponding to the electric charge of the two pixels transferred to the FD 93 is read out as a signal level.

Thus, among the pixels PD1 to PD4 in the sharing pixel block, the pixels PD2 and PD3 undergo pixel addition.

### Example of Driving of Pixels (One-Pixel Addition)

Next, with reference to a timing chart of FIG. 10, an example of driving each pixel in the sharing pixel block 80 when one-pixel addition is performed will be described.

Note that, in FIG. 10, an operation performed in the period from the time t41 to the time t44 is similar to the operation of FIG. 7 performed in the period from the time t11 to the time t14, and therefore, the description thereof will be omitted.

That is, at the time t44, when the drive signal TRG3 in pulses is applied, the electric charge accumulated in the photodiode 91-3 is transferred to the FD 93 by the transfer gate 92-3. Thus, a voltage corresponding to the electric charge of the single pixel transferred to the FD 93 is read out as a signal level.

Thus, among the pixels PD1 to PD4 in the sharing pixel block, the pixel PD3 undergoes pixel addition.

By the above-described operation, driving of a predetermined pixel in the sharing pixel block in which pixels share the FD 93 is controlled, and thus, photographing may be performed with more preferable sensitivity, that is, for example, such that the number of pixels to be added may be maximized to perform photographing with high sensitivity, and the number of pixels to be added may be reduced to perform, even without using the ND filter, photographing with as low sensitivity as that achieved when the ND filter is used.

That is, in the related art, as a method for reducing the amount (signal amount) of electric charge accumulated in a photodiode, there are only a method in which the accumulation time (shutter speed) is reduced, a method in which the ND filter is attached to the lens to reduce the amount of light incident on the photodiode.

On the other hand, according to the present technology, the number of pixels to be added in the sharing pixel block may be controlled, and thus, the signal amount S′[e−] may be controlled as represented by Expression 1 below.

$${SignalamountS}^{ ′} [ e \text{-} ] = \frac{The numbern of FDs to be added}{The numberm of pixels sharingan FD} \times SignalamountS [ e \text{-} ] \qquad ( 1 )$$

In Expression 1, the number m of pixels sharing FDs represents the number of the pixels included in the sharing pixel block, the number n of FDs to be added represents the number of pixels to be added. Also, the signal amount S[e−] represents the signal amount when all of the pixels included in the sharing pixel block are driven.

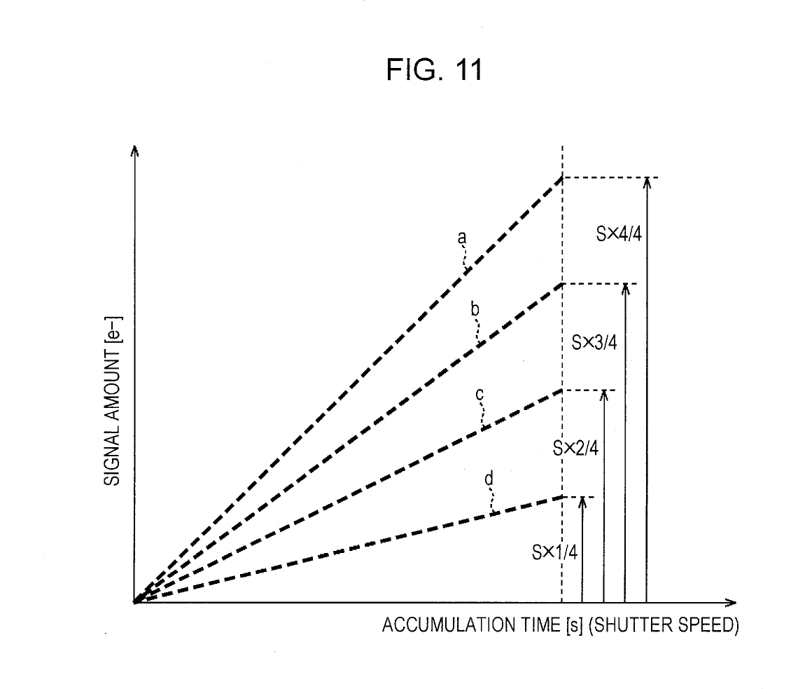

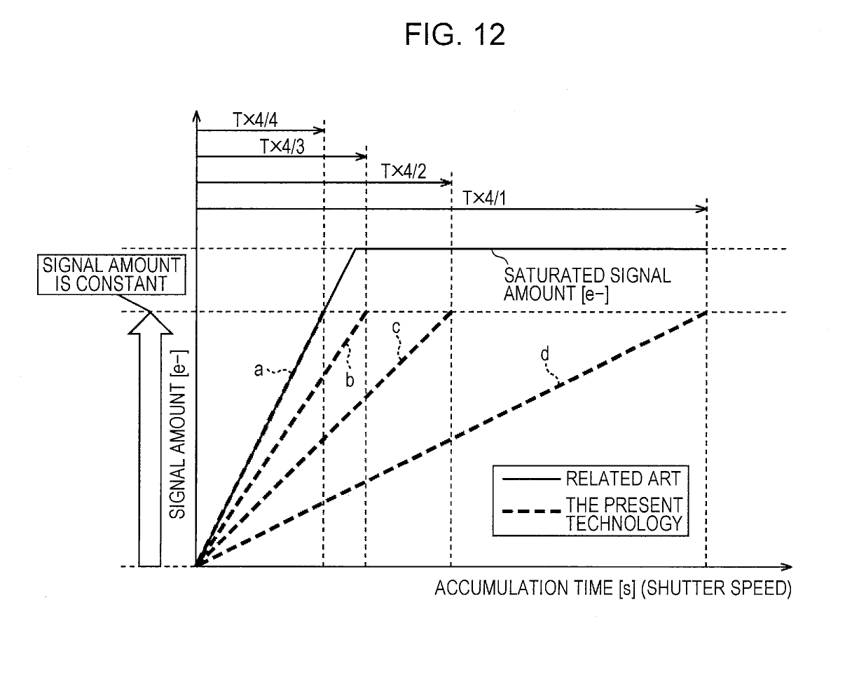

The relationship between the accumulation time and the signal amount for each different number of pixels to be added will be hereinafter described with reference to FIG. 11.

In FIG. 11, the abscissa axis indicates the accumulation time [s] (shutter speed), and the ordinate axis indicates the signal amount [e−]. Also, in FIG. 11, the straight lines a, b, c, and d respectively represent the signal amount S′[e−] when the four-pixel addition is performed, the signal amount S′[e−] when the three-pixel addition is performed, the signal amount S′[e−] when the two-pixel addition is performed, and the signal amount S′[e−] when the one-pixel addition is performed.

As illustrated in FIG. 11, even when the accumulation time is the same, the signal amount S′[e−] when the three-pixel addition is performed, which is represented by the straight line b, is 3/4 of that obtained when the four-pixel addition is performed (represented by the straight line a), and the signal amount S′[e−] when the two-pixel addition is performed, which is represented by the straight line c, is 2/4 of that obtained when the four-pixel addition is performed (represented by the straight line a). The signal amount S′[e−] when the one-pixel addition is performed, which is represented by the straight line d, is 1/4 of that obtained when the four-pixel addition is performed (represented by the straight line a). That is, even when the accumulation time (shutter speed) is the same, the signal amount is controlled in accordance with the number of pixels to be added.

Note that it has been described above that, with the same accumulation time, the signal amount is changed, but according to the present technology, the signal amount may be caused to be the same when the accumulation time differs.

### Application Example 1 of the Present Technology

In the related art, as illustrated in FIG. 12, when the accumulation time is increased, there might be cases where the signal amount is saturated with the saturation signal amount (saturation electric charge amount) of the photodiode assumed as an upper limit (see the solid line of FIG. 12).

Thus, in the present technology, as represented by Expression 2 below, the accumulation time T′[s] is controlled in accordance with the number of pixels to be added in the sharing pixel block (that is, the number of pixels to be driven in the sharing pixel block).

$$Accumulation time {T}^{′} [ s ] = \frac{The numberm of pixels sharingan FD}{The numbern of FDs to be added} \times Accumulation time T [ s ] \qquad ( 2 )$$

In Expression 2, the number m of pixels sharing an FD represents the number of the pixels included in the sharing pixel block, the number n of FDs to be added represents the number of pixels to be added. Also, the accumulation time T[s] represents the accumulation time in which a certain signal amount is accumulated when all of the pixels included in the sharing pixel block are driven.

Thus, as illustrated in FIG. 12, even when the signal amount is the same, the accumulation time T′[s] when the three-pixel addition is performed, which is represented by the straight line b, is 4/3 of that obtained when the four-pixel addition is performed (represented by the straight line a), and the accumulation time T′[s] when the two-pixel addition is performed, which is represented by the straight line c, is 4/2 of that obtained when the four-pixel addition is performed (represented by the straight line a). The accumulation time T′[s] when the one-pixel addition is performed, which is represented by the straight line d, is 4/1 of that obtained when the four-pixel addition is performed (represented by the straight line a). Thus, the accumulation time is controlled in accordance with the pixel addition number, and therefore, the accumulation time may be increased without causing the signal amount to be saturated.

Also, according to the present technology, the F value of the lens may be controlled with the signal amount being set the same.

### Application Example 2 of the Present Technology

In the related art, when the F value of the lens is reduced (that is, when the aperture is opened to increase a brightness), there might be cases where the signal amount is saturated with the saturation signal amount of the photodiode assumed as an upper limit.

Thus, in the present technology, in the above-described imaging device including the CMOS image sensor 30, a lens control section that controls the F value F′ of the lens in accordance with the number of pixels to be added in the sharing pixel block (that is, the number of pixels to be driven in the sharing pixel block), as represented in Expression 3 below, is provided.

$${F}^{′} = \frac{F}{\sqrt{\frac{The numberm of pixels sharingan FD}{The numbern of FDs to be added}}} \qquad ( 3 )$$

In Expression 3, the number m of pixels sharing an FD represents the number of the pixels included in the sharing pixel block, the number n of FDs to be added represents the number of pixels to be added. Also, the F value “F” represents the F value set when all of the pixels included in the sharing pixel block are driven.

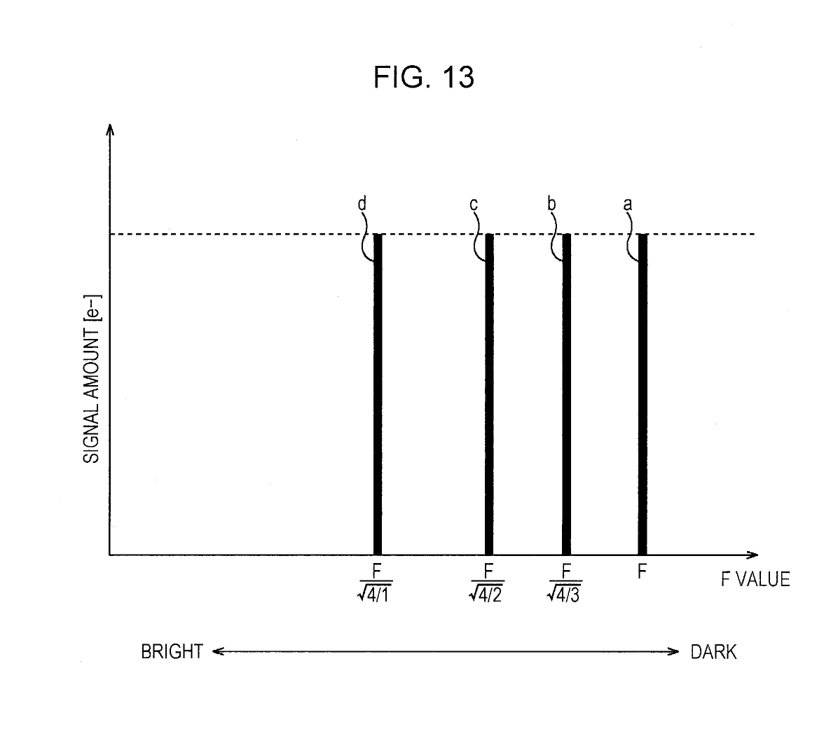

Thus, as illustrated in FIG. 13, even when the signal amount is the same, the F value F′ when the three-pixel addition is performed, which is represented by the straight line b, is 1/√(4/3) of that obtained when the four-pixel addition is performed (represented by the straight line a), and the F value F′ when the two-pixel addition is performed, which is represented by the straight line c, is 1/√(4/2) of that obtained when the four-pixel addition is performed (represented by the straight line a). The F value F′ when the one-pixel addition is performed, which is represented by the straight line d, is 1/√(4/1) of that obtained when the four-pixel addition is performed (represented by the straight line a). Thus, the F value F′ of the lens is controlled in accordance with the number of pixels to be added, and therefore, the F value of the lens may be reduced (the aperture is opened) without causing the signal amount to be saturated, thereby allowing photographing an image with a shallow depth of field.

Furthermore, according to the present technology, a wide dynamic range of a solid-state imaging device may be achieved.

### Achieving Dynamic Range

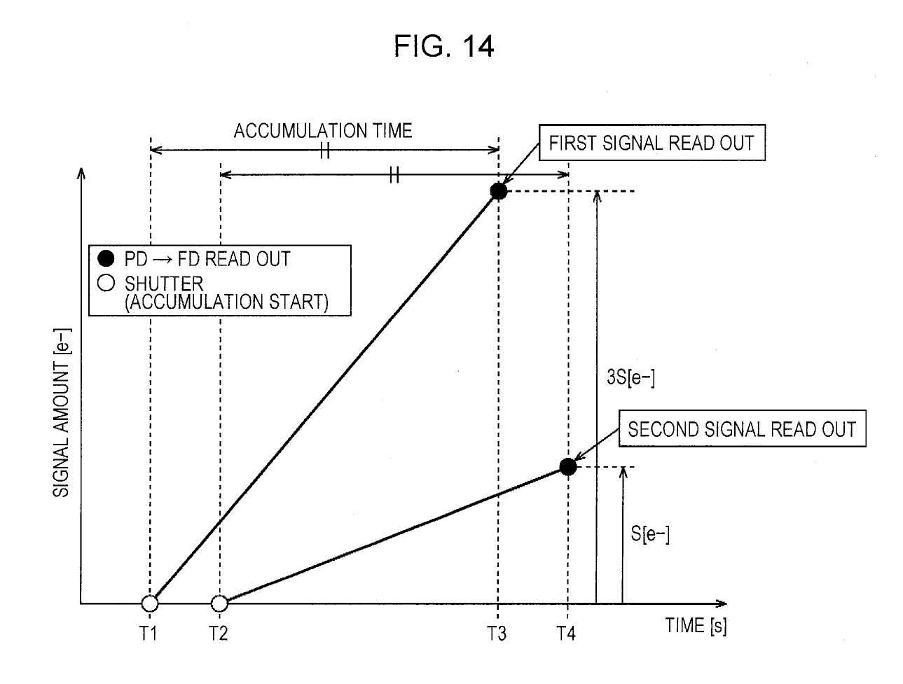

Reading out of the pixels included in the sharing pixel block is performed by a plurality of separate reading operations. Specifically, for example, as illustrated in FIG. 14, a shutter operation for three pixels among the pixels included in the sharing pixel block 80 is first performed at the time T1. Subsequently, at the time T2, a shutter operation for a remaining single pixel among the pixels included in the sharing pixel block 80 is caused to be performed.

Then, at the time T3 after a certain accumulation time has elapsed sine the time T1, signal read out (first signal read out) for three pixels among the pixels included in the sharing pixel block 80 is caused to be performed. Furthermore, at the time T4 after a certain accumulation time elapsed since the time T2, signal read out for a remaining single pixel among the pixels included in the sharing pixel block 80 (second signal read out) is performed.

Thus, a signal with the signal amount 3S[e−] is read out by the first signal read out, a signal with the signal amount S[e−] is read out by the second signal read out, and the signals are combined in a subsequent stage. Note that, the accumulation time (from the time T1 to the time T3) for the three pixels among the pixels included in the sharing pixel block 80 is the same as the accumulation time (from the time T2 to the time T4) for the remaining single pixel among the pixels included in the sharing pixel block 80, but the start timing differs between the accumulation times.

As described above, signals with different sensitivities are read out by a plurality of separate reading operations and are combined in a subsequent stage, and thus, the dynamic range of the signal amount may be increased.

An example of driving each pixel in the sharing pixel block 80 performed when reading out of the pixels is performed by a plurality of separate reading operations will be hereinafter described.

### Example of Driving of Pixels (Three-Pixel Read Out and One-Pixel Read Out)

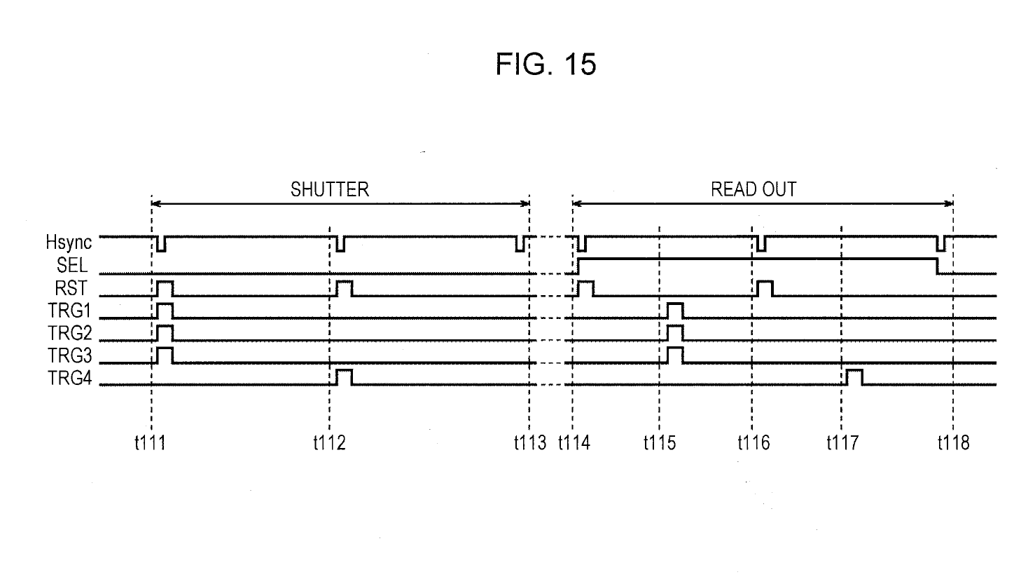

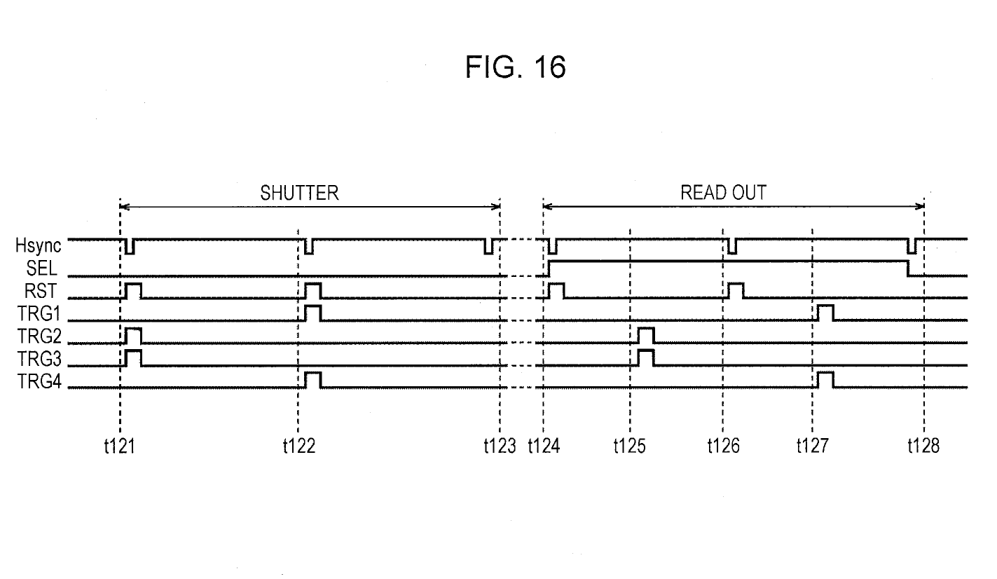

First, with reference to a timing chart of FIG. 15, an example of driving each pixel in the sharing pixel block 80 when pixel read out is performed twice, that is, when three-pixel read out and one-pixel read out are performed will be described.

In FIG. 15, “Hsync” represents a horizontal synchronization signal, and a cycle of the horizontal synchronization signal is a period in which pixel signals in a single row are output.

First, in the shutter period from the time t111 to the time t113, when the drive signals RST and TRG1 to TRG3 in pulses are applied at the time t111, the electric charges accumulated in the photodiodes 91-1 to 91-3 and FD 93 are discharged.

Thus, the electric charges which have been accumulated in the photodiodes 91-1 to 91-3 by the time are swept and electric charge newly obtained from light from an object is accumulated in the photodiodes 91-1 to 91-3.

Also, when the drive signals RST and TRG4 in pulses are applied at the time t112, the electric charges accumulated in the photodiode 91-4 and the FD 93 are discharged.

Thus, the electric charge which has been accumulated in the photodiode 91-4 by the time is swept and electric charge newly obtained from light from the object is accumulated in the photodiode 91-4.

Next, in the read period from the time t114 to the time t118, first, the drive signal SEL is changed from the L level to the H level at the time t114, the drive signal RST in pulses is applied, and the electric charge accumulated in the FD 93 is discharged.

Thereafter, at the time t115, when the drive signals TRG1 to TRG3 in pulses are applied, the electric charges accumulated in the photodiodes 91-1 to 91-3 are transferred to the FD 93 by the transfer gates 92-1 to 92-3, respectively. Thus, a voltage corresponding to the electric charge of the three pixels transferred to the FD 93 is read out as a signal level.

Also, the drive signal RST in pulses is applied at the time t116, and the electric charge accumulated in the FD 93 is discharged.

Thereafter, at the time t117, when the drive signal TRG4 in pulses is applied, the electric charge accumulated in the photodiode 91-4 is transferred to the FD 93 by the transfer gate 92-4. Thus, a voltage corresponding to the electric charge of the single pixel transferred to the FD 93 is read out as a signal level.

Thus, in the sharing pixel block, pixel read out is performed twice, that is, reading out of the pixels PD1 to PD3 and reading out of the pixel PD4 are performed.

### Example of Driving of Pixels (Two-Pixel Read Out and Two-Pixel Read Out)

Next, with reference to a timing chart of FIG. 16, an example of driving each pixel in the sharing pixel block 80 when pixel read out is performed twice, that is, when two-pixel read out and two-pixel read out are performed will be described.

First, in the shutter period from the time t121 to the time t123, when the drive signals RST, TRG2, and TRG3 in pulses are applied at the time t121, the electric charges accumulated in the photodiodes 91-2 and 91-3 and FD 93 are discharged.

Thus, the electric charges which have been accumulated in the photodiodes 91-2 and 91-3 by the time are swept and electric charge newly obtained from light from an object is accumulated in the photodiodes 91-2 and 91-3.

Also, when the drive signals RST, TRG1, and TRG4 in pulses are applied at the time t122, the electric charges accumulated in the photodiodes 91-1 and 91-4 and the FD 93 are discharged.

Thus, the electric charges which have been accumulated in the photodiodes 91-1 and 91-4 by the time are swept and electric charge newly obtained from light from the object is accumulated in the photodiodes 91-1 and 91-4.

Next, in the read period from the time t124 to the time t128, first, the drive signal SEL is changed from the L level to the H level at the time t124, the drive signal RST in pulses is applied, and the electric charge accumulated in the FD 93 is discharged.

Thereafter, at the time t125, when the drive signals TRG2 and TRG3 in pulses are applied, the electric charges accumulated in the photodiodes 91-2 and 91-3 are transferred to the FD 93 by the transfer gates 92-2 and 92-3, respectively. Thus, a voltage corresponding to the electric charge of the two pixels transferred to the FD 93 is read out as a signal level.

Also, the drive signal RST in pulses is applied at the time t126, and the electric charge accumulated in the FD 93 is discharged.

Thereafter, at the time t127, when the drive signals TRG1 and TRG4 in pulses are applied, the electric charges accumulated in the photodiodes 91-1 and 91-4 are transferred to the FD 93 by the transfer gates 92-1 and 92-4. Thus, a voltage corresponding to the electric charge of the two pixels transferred to the FD 93 is read out as a signal level.

Thus, in the sharing pixel block, pixel read out is performed twice, that is, reading out of the pixels PD2 and PD3 and reading out of the pixels PD1 and PD4 are performed.

### Example of Driving of Pixels (Two-Pixel Read Out, One-Pixel Read Out, and One-Pixel Read Out)

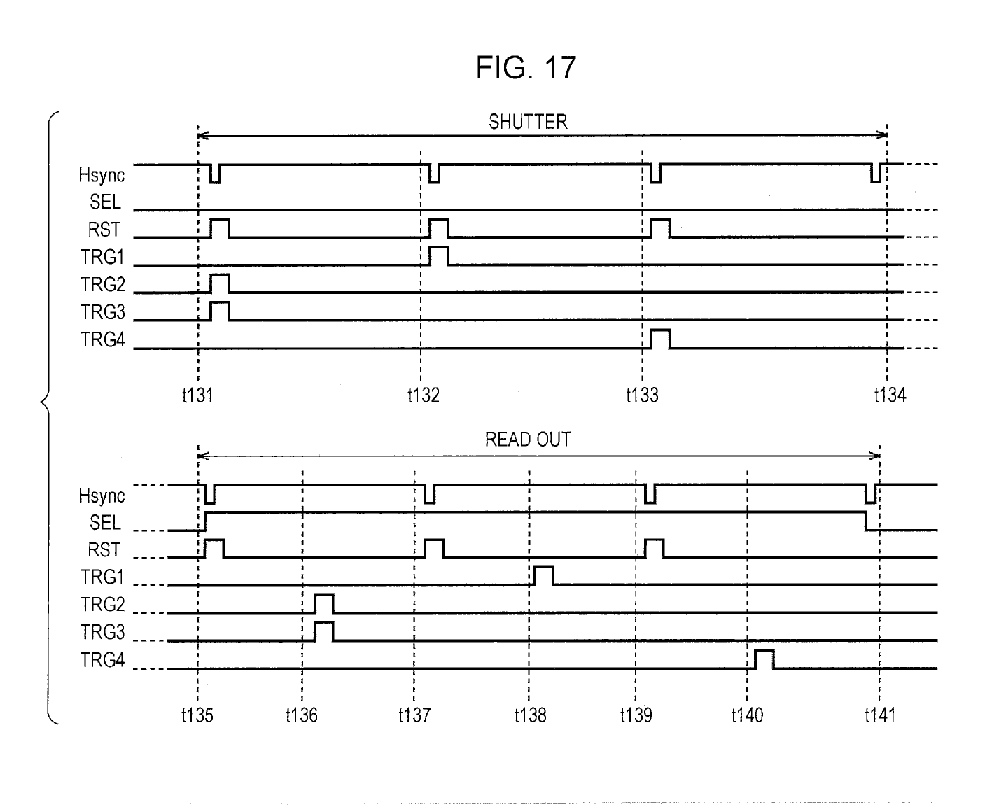

Next, with reference to a timing chart of FIG. 17, an example of driving each pixel in the sharing pixel block 80 when pixel read out is performed three times, that is, when two-pixel read out, one-pixel read out, and one-pixel read out are performed will be described.

First, in the shutter period from the time t131 to the time t134, when the drive signals RST, TRG2, and TRG3 in pulses are applied at the time t131, the electric charges accumulated in the photodiodes 91-2 and 91-3 and FD 93 are discharged.

Thus, the electric charges which have been accumulated in the photodiodes 91-2 and 91-3 by the time are swept and electric charge newly obtained from light from an object is accumulated in the photodiodes 91-2 and 91-3.

Also, when the drive signals RST and TRG1 in pulses are applied at the time t132, the electric charges accumulated in the photodiode 91-1 and the FD 93 are discharged.

Thus, the electric charges which has been accumulated in the photodiode 91-1 by the time is swept and electric charge newly obtained from light from the object is accumulated in the photodiode 91-1.

Furthermore, the drive signals RST and TRG4 in pulses are applied at the time t134, and the electric charges accumulated in the photodiode 91-1 and the FD 93 are discharged.

Thus, the electric charge which has been accumulated in the photodiode 91-4 by the time is swept and electric charge newly obtained from light from the object is accumulated in the photodiode 91-4.

Next, in the read period from the time t135 to the time t141, first, the drive signal SEL is changed from the L level to the H level at the time t135, the drive signal RST in pulses is applied, and the electric charge accumulated in the FD 93 is discharged.

Thereafter, at the time t136, when the drive signals TRG2 and TRG3 in pulses are applied, the electric charges accumulated in the photodiodes 91-2 and 91-3 are transferred to the FD 93 by the transfer gates 92-2 and 92-3, respectively. Thus, a voltage corresponding to the electric charge of the two pixels transferred to the FD 93 is read out as a signal level.

Also, the drive signal RST in pulses is applied at the time t137, and the electric charge accumulated in the FD 93 is discharged.

Thereafter, at the time t138, when the drive signal TRG1 in pulses is applied, the electric charge accumulated in the photodiode 91-1 is transferred to the FD 93 by the transfer gate 92-1. Thus, a voltage corresponding to the electric charge of the single pixel transferred to the FD 93 is read out as a signal level.

Furthermore, the drive signal RST in pulses is applied at the time t139, and the electric charge accumulated in the FD 93 is discharged.

Thereafter, at the time t140, when the drive signal TRG4 in pulses is applied, the electric charge accumulated in the photodiode 91-4 is transferred to the FD 93 by the transfer gate 92-4. Thus, a voltage corresponding to the electric charge of the single pixel transferred to the FD 93 is read out as a signal level.

Thus, in the sharing pixel block, pixel read out is performed three times, that is, reading out of the pixels PD2 and PD3, reading out of the pixel PD1, and reading out of the pixel PD4 are performed.

### Example of Driving of Pixels (One-Pixel Read Out, One-Pixel Read Out, One-Pixel Read Out, and One-Pixel Read Out)

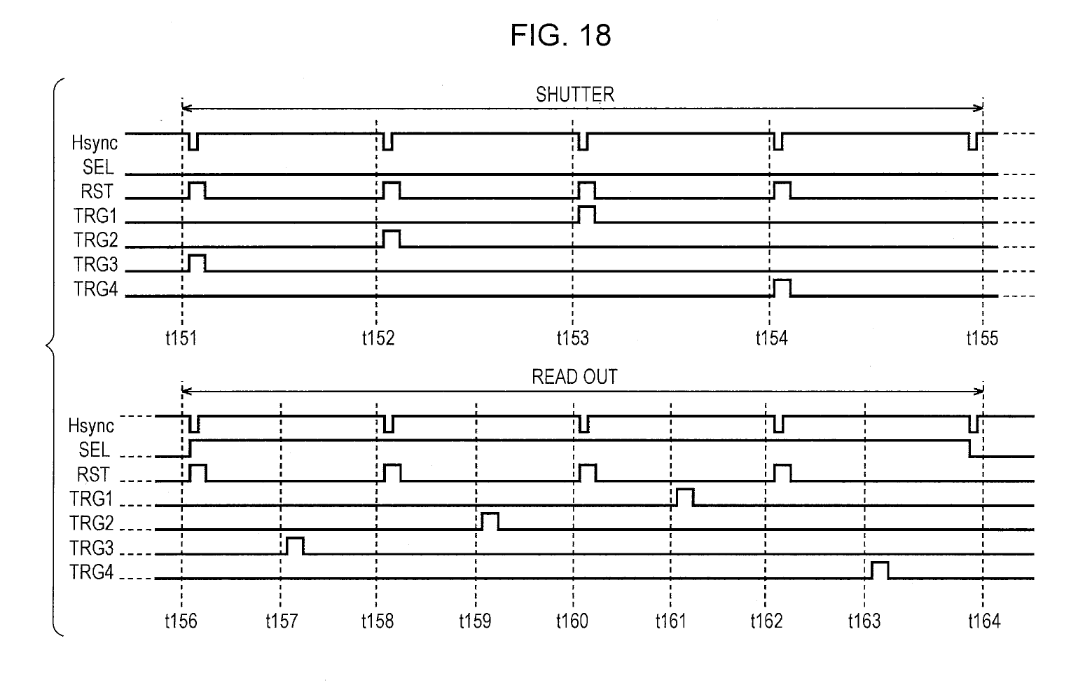

Next, with reference to a timing chart of FIG. 18, an example of driving each pixel in the sharing pixel block 80 when pixel read out is performed four times, that is, when one-pixel read out, one-pixel read out, one-pixel read out, and one-pixel read out are performed will be described.

First, in the shutter period from the time t151 to the time t155, when the drive signals RST and TRG3 in pulses are applied at the time t151, the electric charges accumulated in the photodiode 91-3 and FD 93 are discharged.

Thus, the electric charge which has been accumulated in the photodiode 91-3 by the time is swept and electric charge newly obtained from light from an object is accumulated in the photodiode 91-3.

Also, when the drive signals RST and TRG2 in pulses are applied at the time t152, the electric charges accumulated in the photodiode 91-2 and the FD 93 are discharged.

Thus, the electric charge which has been accumulated in the photodiode 91-2 by the time is swept and electric charge newly obtained from light from the object is accumulated in the photodiode 91-2.

Furthermore, the drive signals RST and TRG1 in pulses are applied at the time t153, and the electric charges accumulated in the photodiode 91-1 and the FD 93 are discharged.

Thus, the electric charge which has been accumulated in the photodiode 91-1 by the time is swept and electric charge newly obtained from light from the object is accumulated in the photodiode 91-1.

Furthermore, the drive signals RST and TRG4 in pulses are applied at the time t154, and the electric charges accumulated in the photodiode 91-4 and the FD 93 are discharged.

Thus, the electric charge which has been accumulated in the photodiode 91-4 by the time is swept and electric charge newly obtained from light from the object is accumulated in the photodiode 91-4.

Next, in the read period from the time t156 to the time t164, first, the drive signal SEL is changed from the L level to the H level at the time t156, the drive signal RST in pulses is applied, and the electric charge accumulated in the FD 93 is discharged.

Thereafter, at the time t157, when the drive signal TRG3 in pulses is applied, the electric charge accumulated in the photodiode 91-3 is transferred to the FD 93 by the transfer gate 92-3. Thus, a voltage corresponding to the electric charge of the single pixel transferred to the FD 93 is read out as a signal level.

Also, the drive signal RST in pulses is applied at the time t158, and the electric charge accumulated in the FD 93 is discharged.

Thereafter, at the time t159, when the drive signal TRG2 in pulses is applied, the electric charge accumulated in the photodiode 91-2 is transferred to the FD 93 by the transfer gate 92-2. Thus, a voltage corresponding to the electric charge of the single pixel transferred to the FD 93 is read out as a signal level.

Furthermore, the drive signal RST in pulses is applied at the time t160, and the electric charge accumulated in the FD 93 is discharged.

Thereafter, at the time t161, when the drive signal TRG1 in pulses is applied, the electric charge accumulated in the photodiode 91-1 is transferred to the FD 93 by the transfer gate 92-1. Thus, a voltage corresponding to the electric charge of the single pixel transferred to the FD 93 is read out as a signal level.

Furthermore, the drive signal RST in pulses is applied at the time t162, and the electric charge accumulated in the FD 93 is discharged.

Thereafter, at the time t163, when the drive signal TRG4 in pulses is applied, the electric charge accumulated in the photodiode 91-4 is transferred to the FD 93 by the transfer gate 92-4. Thus, a voltage corresponding to the electric charge of the single pixel transferred to the FD 93 is read out as a signal level.

Thus, in the sharing pixel block, pixel read out is performed four times, that is, reading out of the pixel PD3, reading out of the pixel PD2, reading out of the pixel PD1, and reading out of the pixel PD4 are performed.

In the above-described CMOS image sensor 30, a single AND gate 74 and a single driver circuit 75 are provided for each pixel included in a pixel row, and thus, the pixels in the sharing pixel block, which are included in the same row, are individually driven.

However, all of the pixels which are included in the same row in the sharing pixel block, do not have to be individually driven and, when some of the pixels are driven together, a single AND gate 74 and a single driver circuit 75 may be provided for the pixels driven together.

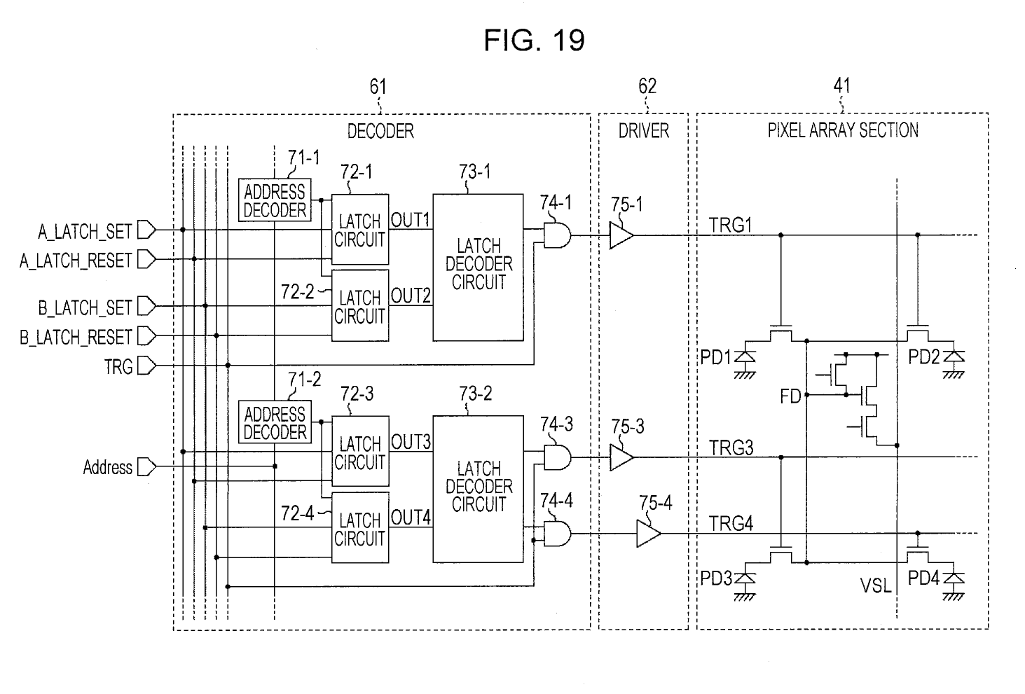

Specifically, for example, in the pixel array section 41 of FIG. 2, when the pixels PD1 and PD2 included in the same row in the sharing pixel block are driven together, as illustrated in FIG. 19, only the AND gate 74-1 and the driver circuit 75-1 may be provided for the pixels PD1 and PD2, and the AND gate 74-2 and the driver circuit 75-2 may be omitted. In this case, the pixels PD1 and PD2 are driven by the control signal TRG1.

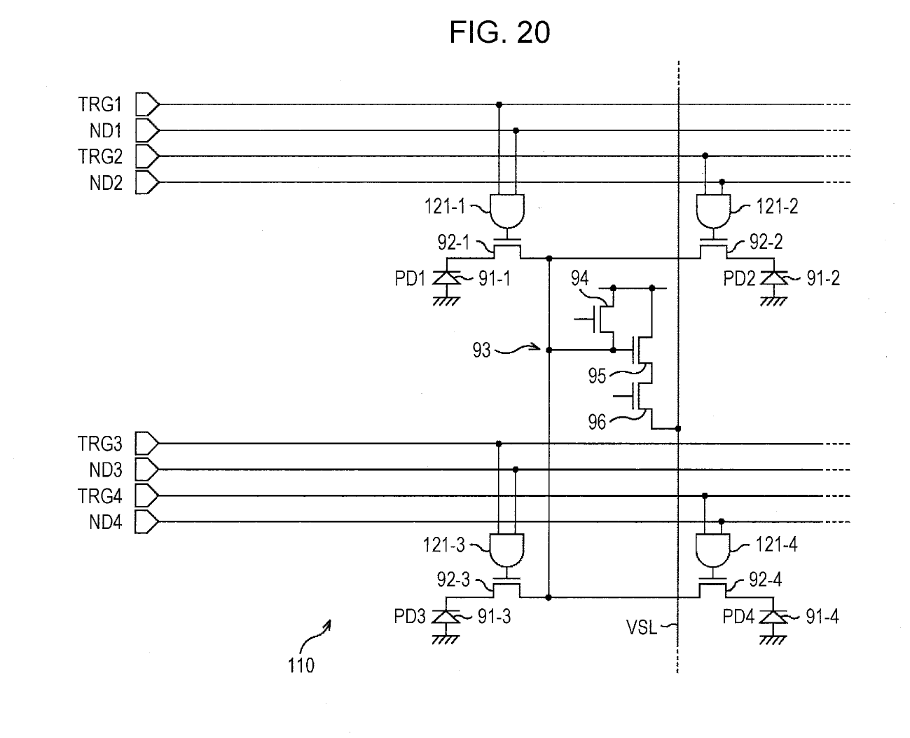

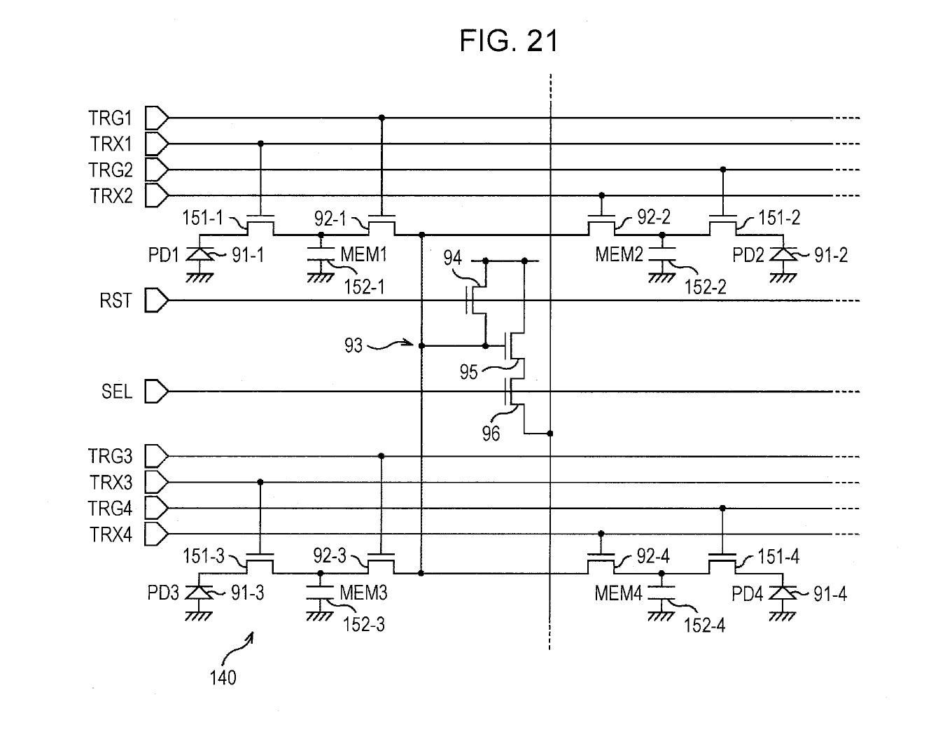

The configuration of the sharing pixel block constituting an image sensor that performs the above-described operation may be adopted to a configuration other than the configuration of the sharing pixel block illustrated in FIG. 6. Another configuration of the sharing pixel block to which the present technology is applicable will be hereinafter described. In FIG. 20 and FIG. 21, parts corresponding to those of FIG. 6 are identified by the same reference characters and the description thereof will be appropriately omitted.

### Another Circuit Configuration Example of Sharing Pixel Block

FIG. 20 is a diagram illustrating another configuration example of the sharing pixel block in the CMOS image sensor 30 to which the present technology is applied.

In a sharing pixel block 110 of FIG. 20, in addition to the components of the configuration illustrated in FIG. 6, AND gates 121-1 to 121-4 are provided.

The AND gates 121-1 to 121-4 are logic circuits that switches on and off the drive signals TRG1 to TRG4 for the driving pixels PD1 to PD4, respectively, on the basis of drive signals ND1 to ND4 from the system control section 45.

That is, the system control section 45 controls driving of the AND gates 121-1 to 121-4.

Specifically, for example, with focus on the pixel PD1, if, when the H level drive signal TRG1 is supplied from the vertical driving section 42 (the driver circuit 75-1), the H level drive signal ND1 is supplied from the system control section 45, the AND gate 121-1 supplies the H level drive signal TRG1 to the transfer gate 92-1. In this case, the transfer gate 92-1 switches on transfer of electric charge from the photodiode 91-1 to the FD 93.

If, when the H level drive signal TRG1 from the vertical driving section 42 (the driver circuit 75-1), the L level drive signal ND1 is supplied from the system control section 45, the AND gate 121-1 supplies the L level drive signal TRG1 to the transfer gate 92-1. In this case, the transfer gate 92-1 switches off transfer of electric charge from the photodiode 91-1 to the FD 93.

This operation is performed in a similar manner on the pixels PD2 to PD4. Thus, also in the sharing pixel block 110, a similar operation to the above-described operation in the sharing pixel block 80 is performed.

Note that, when a sharing pixel block has the circuit configuration of the sharing pixel block 110 illustrated in FIG. 20, in the decoder 61 (FIG. 2), the latch circuits 72, the latch decoder circuits 73, and the AND gates 74 are not provided and drive signals are directly supplied to the driver circuits 75 corresponding to the pixels included in a pixel row selected by the address decoders 71.

As long as the above-described operation is realized, the logic circuits provided in the sharing pixel block 110 are not limited to the AND gates 121-1 to 121-4 but may be other logical circuits.

### Still Another Circuit Configuration Example of Sharing Pixel Block

FIG. 21 is a diagram illustrating still another configuration example of the sharing pixel block in the CMOS image sensor 30 to which the present technology is applied.

In a sharing pixel block 140 of FIG. 21, in addition to the components of the configuration illustrated in FIG. 6, transfer gates 151-1 to 151-4 and memory sections 152-1 to 152-4 (MEM1 to MEM4) are provided such that each of the transfer gates 151-1 to 151-4 and each of the memory sections 152-1 to 152-4 between a corresponding one of the photodiodes 91-1 to 91-4 and a corresponding one of the transfer gates 92-1 to 92-4.

Note that, when the transfer gates 151-1 to 151-4 and the memory sections 152-1 to 152-4 do not have to be individually distinguished from one another, the transfer gates 151-1 to 151-4 and the memory sections 152-1 to 152-4 are merely referred to as “transfer gates 151” and “memory sections 152”, respectively.

In response to drive signals TRX1 to TRX4 applied to gate electrodes of the transfer gates 151, the transfer gates 151 transfer electric charges obtained by photoelectric conversion by the photodiodes 91 and accumulated in the photodiodes 91. The memory sections 152 accumulate the electric charges transferred from the photodiodes 91 by the transfer gates 151.

When the drive signal TRG is applied to the gate electrode of the transfer gate 92, the transfer gate 92 transfers the electric charge accumulated in the memory section 152 to the FD 93.

With the above-described configuration, the CMOS image sensor 30 may perform global exposure (global shutter operation). In this configuration, driving of a predetermined pixel in the sharing pixel block in which pixels share the FD 93 is controlled, and the same driving as that for the sharing pixel block 80 is performed.

### Example of Driving of Pixels (Four-Pixel Addition)

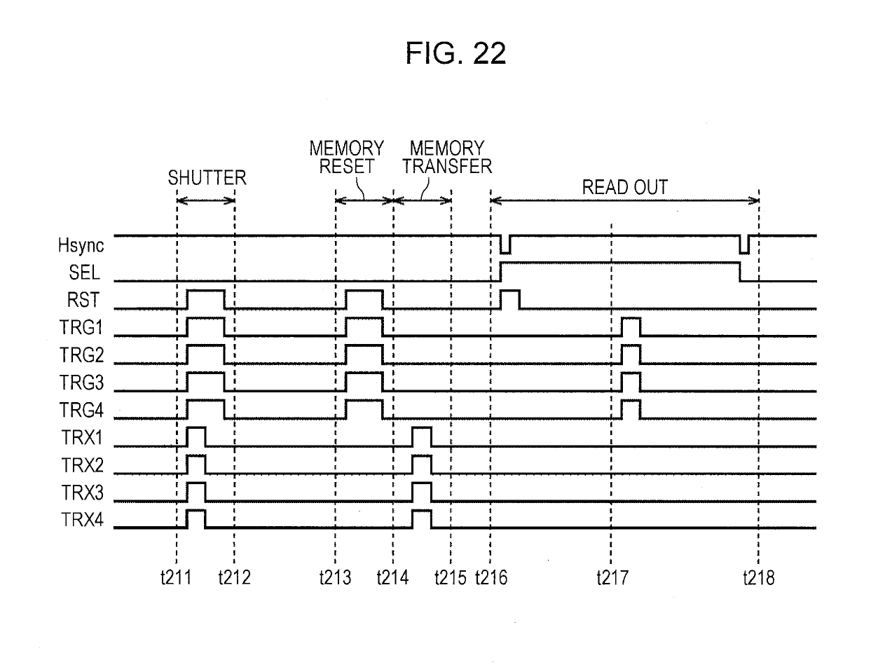

With reference to a timing chart of FIG. 22, an example of driving each pixel in the sharing pixel block 140 when four-pixel addition is performed will be hereinafter described.

In FIG. 22, “Hsync” represents a horizontal synchronization signal, and a cycle of the horizontal synchronization signal is a period in which pixel signals in a single row are output.

First, in the period from the time t211 to the time t212, when the drive signals RST, TRG1 to TRG4, and TRX1 to TRX4 in pulses are applied, the electric charges accumulated in the photodiodes 91-1 to 91-4, the memory sections 152-1 to 152-4, and FD 93 are discharged.

Thus, the electric charges which have been accumulated in the photodiodes 91-1 to 91-4 by the time are swept and an electric charge newly obtained from light from an object is accumulated in the photodiodes 91-1 to 91-4 in the period from t212 to t215. Note that, in the period from t213 to t214, the drive signals RST, and TRG1 to TRG4 in pulses are applied, and thus, the electric charges accumulated in the memory sections 152-1 to 152-4 and the FD 93 are initialized (reset).

In the period from t214 to t215, when the drive signals TRX1 to TRX4 are applied, the electric charges accumulated in the photodiodes 91-1 to 91-4 are transferred to the memory sections 152-1 to 152-4 by the transfer gates 151-1 to 151-4, respectively.

Next, in the read period from the time t216 to the time t218, first, the drive signal SEL is changed from the L level to the H level at the time t216, the drive signal RST in pulses is applied, and the electric charge accumulated in the FD 93 is discharged.

Thereafter, at the time t217, when the drive signals TRG1 to TRG4 in pulses are applied, the electric charges accumulated in the memory sections 152-1 to 152-4 are transferred to the FD 93 by the transfer gates 92-1 to 92-4, respectively. Thus, a voltage corresponding to the electric charge of the four pixels transferred to the FD 93 is read out as a signal level.

Thus, all of the pixels PD1 to PD4 in the sharing pixel block undergo pixel addition.

### Example of Driving of Pixels (Three-Pixel Addition)

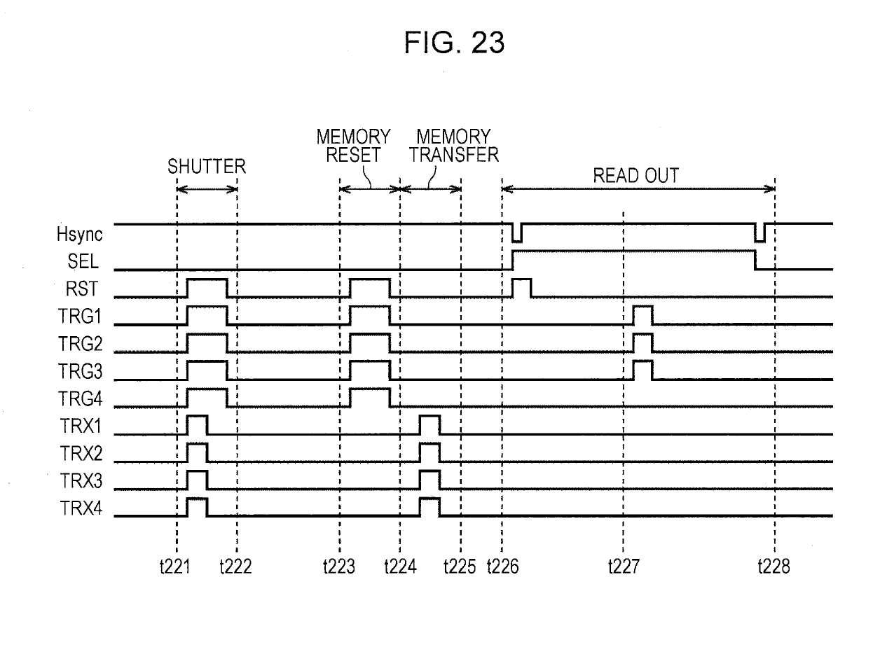

Next, with reference to a timing chart of FIG. 23, an example of driving each pixel in the sharing pixel block 140 when three-pixel addition is performed will be described.

Note that, in FIG. 23, an operation performed in the period from the time t221 to the time t227 is similar to the operation of FIG. 22 performed in the period from the time t211 to the time t217, and therefore, the description thereof will be omitted.

That is, at the time t227, when the drive signals TRG1 to TRG3 in pulses are applied, the electric charges accumulated in the memory sections 152-1 to 152-3 are transferred to the FD 93 by the transfer gates 92-1 to 92-3, respectively. Thus, a voltage corresponding to the electric charge of the three pixels transferred to the FD 93 is read out as a signal level.

Thus, the pixels PD1 to PD3 among the pixels PD1 to PD4 in the sharing pixel block undergo pixel addition.

### Example of Driving of Pixels (Two-Pixel Addition)

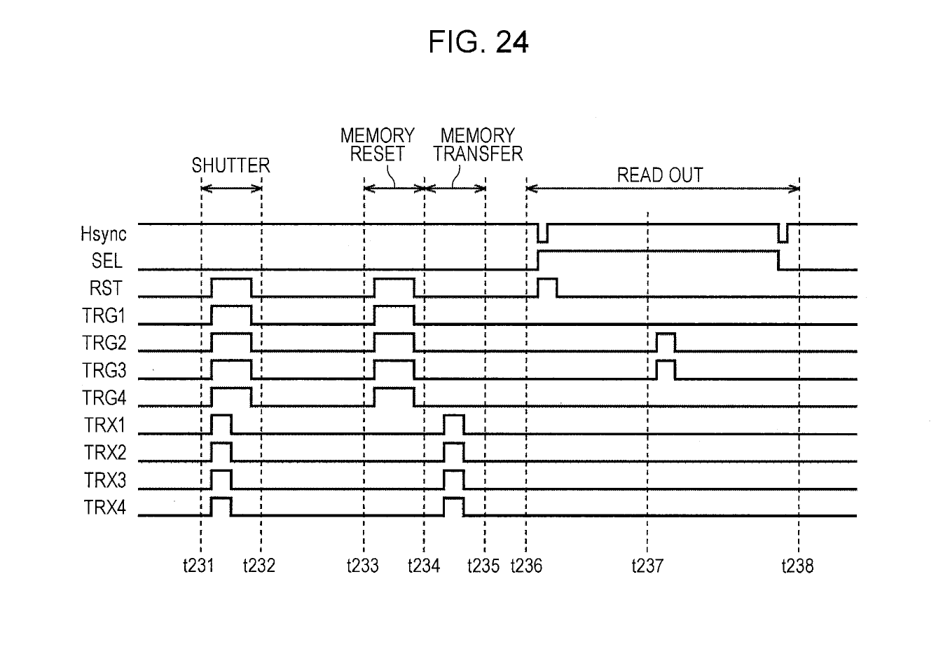

Next, with reference to a timing chart of FIG. 24, an example of driving each pixel in the sharing pixel block 140 when two-pixel addition is performed will be described.

Note that, in FIG. 24, an operation performed in the period from the time t231 to the time t237 is similar to the operation of FIG. 22 performed in the period from the time t211 to the time t217, and therefore, the description thereof will be omitted.

That is, at the time t237, when the drive signals TRG2 and TRG3 in pulses are applied, the electric charges accumulated in the memory sections 152-2 and 152-3 are transferred to the FD 93 by the transfer gates 92-2 to 92-3, respectively. Thus, a voltage corresponding to the electric charge of the two pixels transferred to the FD 93 is read out as a signal level.

Thus, the pixels PD2 and PD3 among the pixels PD1 to PD4 in the sharing pixel block undergo pixel addition.

### Example of Driving of Pixels (One-Pixel Addition)

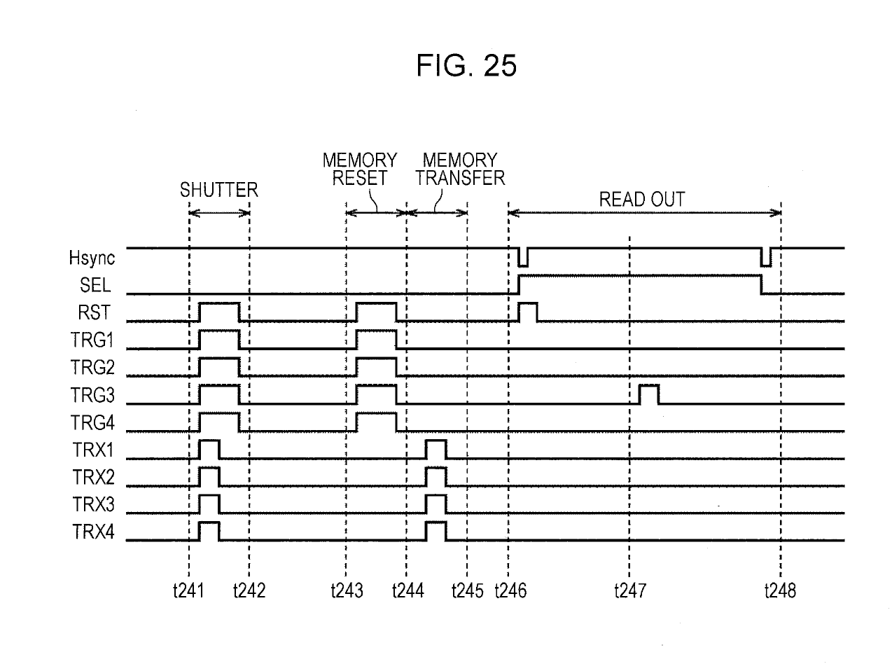

Next, with reference to a timing chart of FIG. 25, an example of driving each pixel in the sharing pixel block 140 when one-pixel addition is performed will be described.

Note that, in FIG. 25, an operation performed in the period from the time t241 to the time t247 is similar to the operation of FIG. 22 performed in the period from the time t211 to the time t217, and therefore, the description thereof will be omitted.

That is, at the time t247, when the drive signal TRG3 in pulses is applied, the electric charge accumulated in the memory section 152-3 is transferred to the FD 93 by the transfer gate 92-3. Thus, a voltage corresponding to the electric charge of the single pixel transferred to the FD 93 is read out as a signal level.

Thus, the pixel PD3 among the pixels PD1 to PD4 in the sharing pixel block undergoes pixel addition.

By the above-described operation, driving of a predetermined pixel in the sharing pixel block in which pixels share the FD 93 is controlled, and thus, photographing may be performed with more preferable sensitivity, that is, for example, the number of pixels to be added may be maximized to perform photographing with high sensitivity, and the number of pixels to be added may be reduced to perform, even without using the ND filter, photographing with as low sensitivity as that achieved when the ND filter is used.

Also, with the configuration of FIG. 21, global shutter operation and global transfer may be performed, when reading out of the pixels included in the sharing pixel block may be performed by a plurality of separate reading operations in order to achieve a wide dynamic range, the shutter operations of the pixels may be performed with the same timing.

### Achieving Wide Dynamic Range

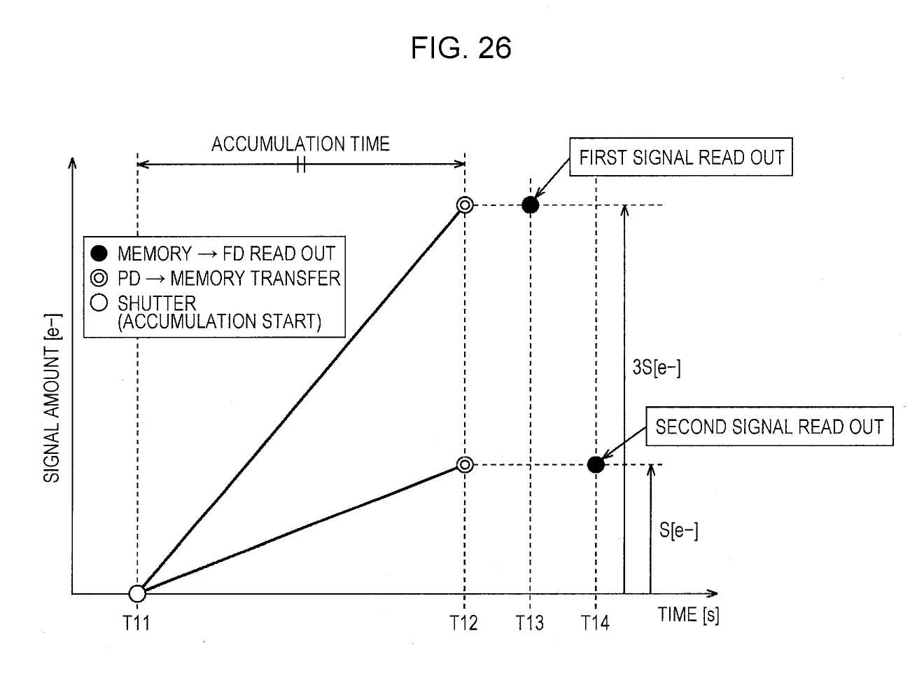

Specifically, for example, as illustrated in FIG. 26, a shutter operation for four pixels among the pixels included in the sharing pixel block 140 is first performed at the time T11.

Next, at the time T12 after a certain accumulation time has elapsed sine the time T11, memory transfer for four pixels among the pixels included in the sharing pixel block 140 is caused to be performed.

Then, at the time T13, signal read out (first signal read out) for three pixels among the pixels included in the sharing pixel block 140 is caused to be performed. Furthermore, at the time T14, signal read out for a remaining single pixel among the pixels included in the sharing pixel block 140 (second signal read out) is performed.

Thus, a signal with the signal amount 3S[e−] is read out by the first signal read out, a signal with the signal amount S[e−] is read out by the second signal read out, and the signals are combined in a subsequent stage. Note that, the accumulation time (from the time T11 to the time T14) for the four pixels among the pixels included in the sharing pixel block 140 is all the same, and the start timing of the accumulation time is all the same for the four pixels.

As described above, signals with different sensitivities are read out by a plurality of separate reading operations and are combined in a subsequent stage, and thus, the dynamic range of the signal amount may be increased.

Also, in the operation of FIG. 26, the start timings of the shutter operation timings for the pixels included in the sharing pixel block 140 may be caused to be all the same, and therefore, as opposed to the operation described with reference to FIG. 21, the start timings of the shutter operations do not have to be varied, and thus, the uniformity on the time axis is not lost. Therefore, the dynamic range of the signal amount may be increased with higher accuracy.

An example of driving each pixel in the sharing pixel block 140 performed when reading out of pixels is performed by a plurality of separate reading operations will be hereinafter described.

### Example of Driving of Pixels (Three-Pixel Read Out and One-Pixel Read Out)

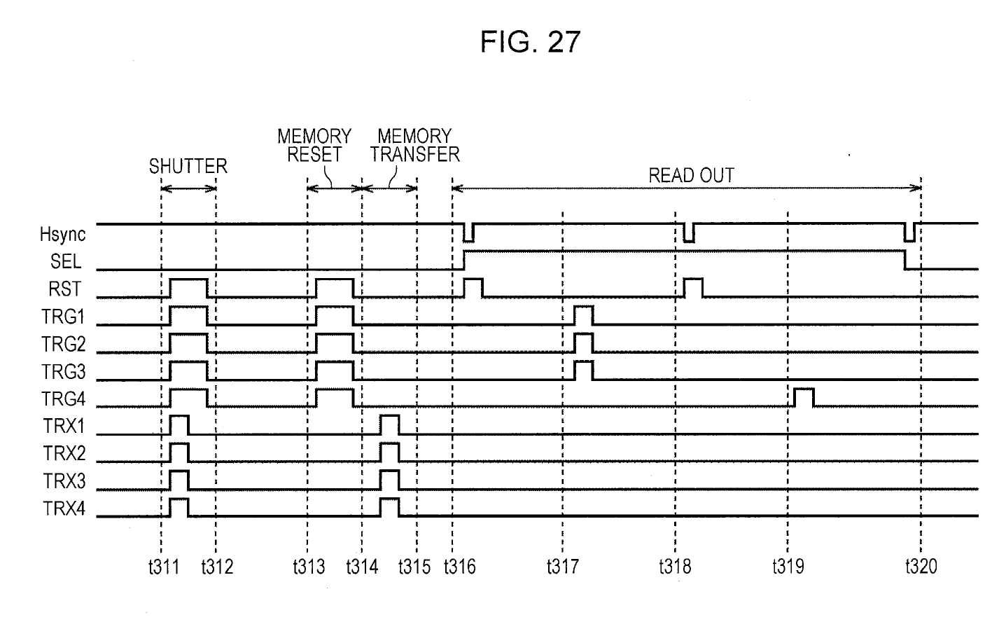

First, with reference to a timing chart of FIG. 27, an example of driving each pixel in the sharing pixel block 140 when pixel read out is performed twice, that is, when three-pixel read out and one-pixel read out are performed will be described.

Note that, in FIG. 27, the operation performed in the period from the time t311 to the time t317 is similar to the operation of FIG. 22 performed in the period from the time t211 to the time t217, and therefore, the description thereof will be omitted.

That is, at the time t317, when the drive signals TRG1 to TRG3 in pulses are applied, the electric charges accumulated in the memory sections 152-1 to 152-3 are transferred to the FD 93 by the transfer gates 92-1 to 92-3, respectively. Thus, a voltage corresponding to the electric charge of the three pixels transferred to the FD 93 is read out as a signal level.

Also, at the time t318, the drive signal RST in pulses is applied, and the electric charge accumulated in the FD 93 is discharged.

Thereafter, at the time t319, when the drive signal TRG4 in pulses is applied, the electric charge accumulated in the memory section 152-4 is transferred to the FD 93 by the transfer gate 92-4. Thus, a voltage corresponding t the electric charge of the single pixel transferred to the FD 93 is read out as a signal level.

Thus, in the sharing pixel block, pixel read out is performed twice, that is, reading out of the pixels PD1 to PD3 and reading out of the pixel PD4 are performed.

### Example of Driving of Pixels (Two-Pixel Read Out and Two-Pixel Read Out)

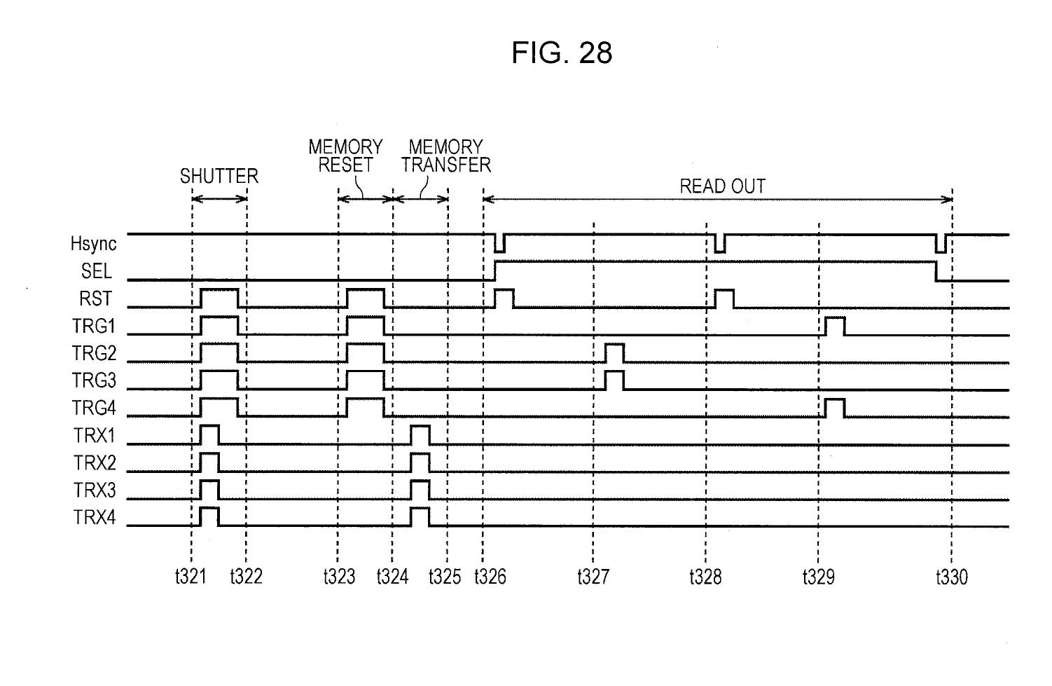

Next, with reference to a timing chart of FIG. 28, an example of driving each pixel in the sharing pixel block 140 when pixel read out is performed twice, that is, when two-pixel read out and two-pixel read out are performed will be described.

Note that, in FIG. 28, the operation performed in the period from the time t321 to the time t327 is similar to the operation of FIG. 22 performed in the period from the time t211 to the time t217, and therefore, the description thereof will be omitted.

That is, at the time t327, when the drive signals TRG2 and TRG3 in pulses are applied, the electric charges accumulated in the memory sections 152-2 and 152-3 are transferred to the FD 93 by the transfer gates 92-2 and 92-3, respectively. Thus, a voltage corresponding to the electric charge of the two pixels transferred to the FD 93 is read out as a signal level.

Also, at the time t328, the drive signal RST in pulses is applied, and the electric charge accumulated in the FD 93 is discharged.

Thereafter, at the time t329, when the drive signals TRG1 and TRG4 in pulses are applied, the electric charges accumulated in the memory sections 152-1 and 152-4 are transferred to the FD 93 by the transfer gates 92-1 and 92-4. Thus, a voltage corresponding to the electric charge of the two pixels transferred to the FD 93 is read out as a signal level.

Thus, in the sharing pixel block, pixel read out is performed twice, that is, reading out of the pixels PD2 and PD3 and reading out of the pixels PD1 and PD4 are performed.

### Example of Driving of Pixels (Two-Pixel Read Out, One-Pixel Read Out, and One-Pixel Read Out)

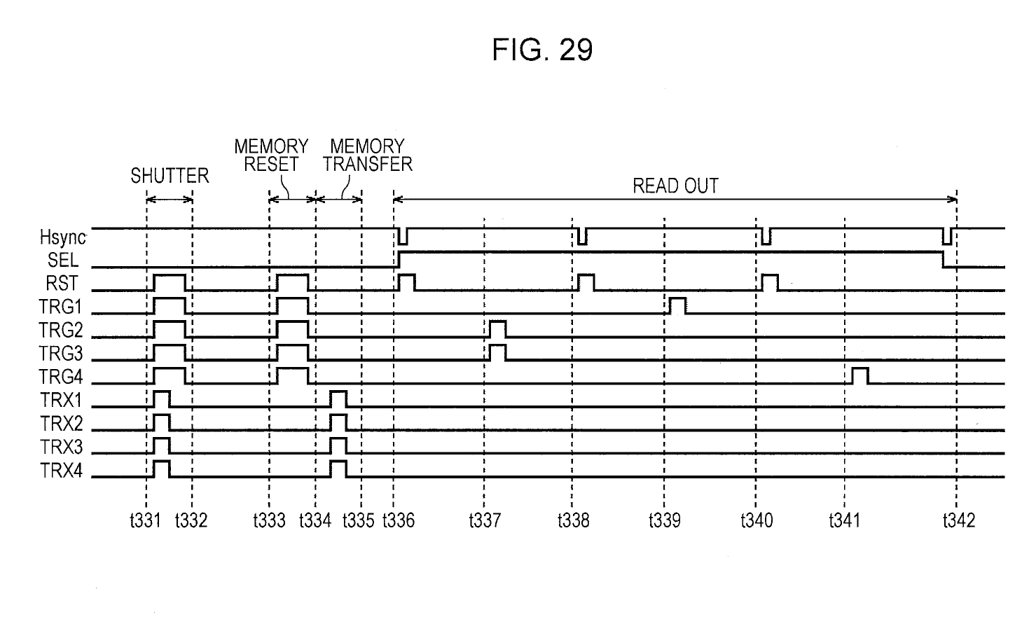

Next, with reference to a timing chart of FIG. 29, an example of driving each pixel in the sharing pixel block 140 when pixel read out is performed three times, that is, when two-pixel read out, one-pixel read out, and one-pixel read out are performed will be described.

Note that, in FIG. 29, the operation performed in the period from the time t331 to the time t337 is similar to the operation of FIG. 22 performed in the period from the time t211 to the time t217, and therefore, the description thereof will be omitted.

That is, at the time t337, when the drive signals TRG2 and TRG3 in pulses are applied, the electric charges accumulated in the memory sections 152-2 and 152-3 are transferred to the FD 93 by the transfer gates 92-2 and 92-3, respectively. Thus, a voltage corresponding to the electric charge of the two pixels transferred to the FD 93 is read out as a signal level.

Also, the drive signal RST in pulses is applied at the time t338, and the electric charge accumulated in the FD 93 is discharged.

Thereafter, at the time t339, when the drive signal TRG1 in pulses is applied, the electric charge accumulated in the memory section 152-1 is transferred to the FD 93 by the transfer gate 92-1. Thus, a voltage corresponding to the electric charge of the single pixel transferred to the FD 93 is read out as a signal level.

Furthermore, the drive signal RST in pulses is applied at the time t340, and the electric charge accumulated in the FD 93 is discharged.

Thereafter, at the time t341, when the drive signal TRG4 in pulses is applied, the electric charge accumulated in the memory section 152-4 is transferred to the FD 93 by the transfer gate 92-4. Thus, a voltage corresponding to the electric charge of the single pixel transferred to the FD 93 is read out as a signal level.

Thus, in the sharing pixel block, pixel read out is performed three times, that is, reading out of the pixels PD2 and PD3, reading out of the pixel PD1, and reading out of the pixel PD4 are performed.

### Example of Driving of Pixels (One-Pixel Read Out, One-Pixel Read Out, One-Pixel Read Out, and One-Pixel Read Out)

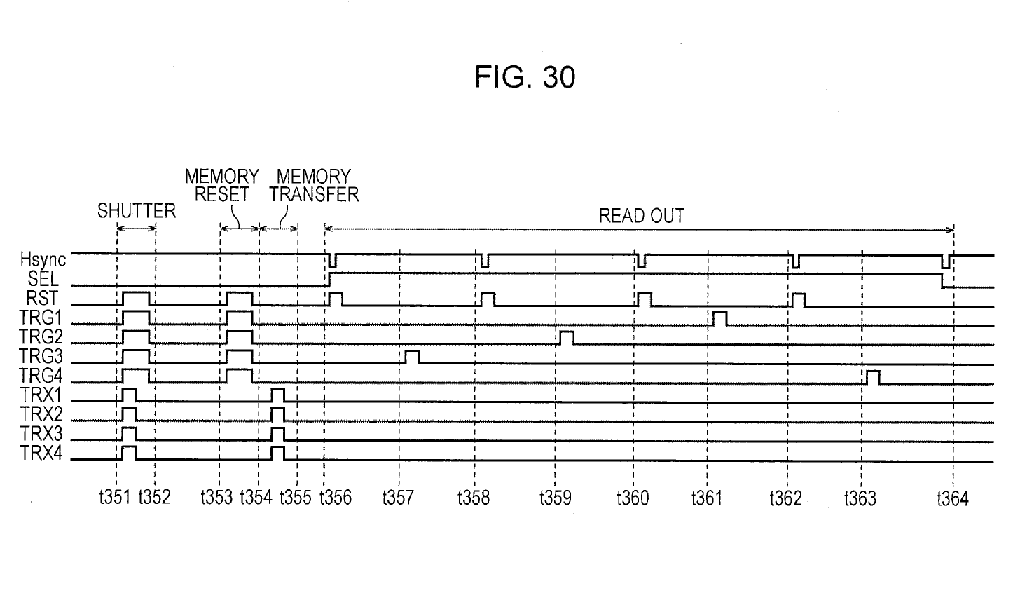

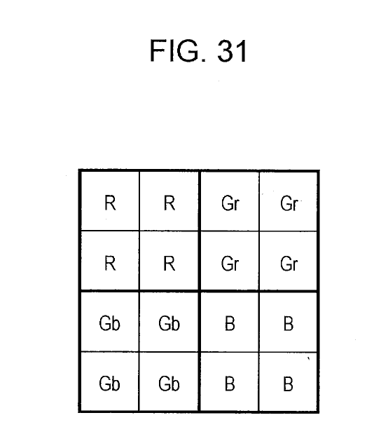

Next, with reference to a timing chart of FIG. 30, an example of driving each pixel in the sharing pixel block 140 when pixel read out is performed four times, that is, when one-pixel read out, one-pixel read out, one-pixel read out, and one-pixel read out are performed will be described.

Note that, in FIG. 30, the operation performed in the period from the time t351 to the time t356 is similar to the operation of FIG. 22 performed in the period from the time t211 to the time t216, and therefore, the description thereof will be omitted.

That is, at the time t357, when the drive signal TRG3 in pulses is applied, the electric charge accumulated in the memory section 152-3 is transferred to the FD 93 by the transfer gate 92-3. Thus, a voltage corresponding to the electric charge of the single pixel transferred to the FD 93 is read out as a signal level.

Also, the drive signal RST in pulses is applied at the time t358, and the electric charge accumulated in the FD 93 is discharged.

Thereafter, at the time t359, when the drive signal TRG2 in pulses is applied, the electric charge accumulated in the memory section 152-2 is transferred to the FD 93 by the transfer gate 92-2. Thus, a voltage corresponding to the electric charge of the single pixel transferred to the FD 93 is read out as a signal level.

Furthermore, the drive signal RST in pulses is applied at the time t360, and the electric charge accumulated in the FD 93 is discharged.

Thereafter, at the time t361, when the drive signal TRG1 in pulses is applied, the electric charge accumulated in the memory section 152-1 is transferred to the FD 93 by the transfer gate 92-1. Thus, a voltage corresponding to the electric charge of the single pixel transferred to the FD 93 is read out as a signal level.

Furthermore, the drive signal RST in pulses is applied at the time t362, and the electric charge accumulated in the FD 93 is discharged.

Thereafter, at the time t363, when the drive signal TRG4 in pulses is applied, the electric charge accumulated in the memory section 152-4 is transferred to the FD 93 by the transfer gate 92-4. Thus, a voltage corresponding to the electric charge of the single pixel transferred to the FD 93 is read out as a signal level.

Thus, in the sharing pixel block, pixel read out is performed four times, that is, reading out of the pixel PD3, reading out of the pixel PD2, reading out of the pixel PD1, and reading out of the pixel PD4 are performed.

### Arrangement of Color Filters

Color filters used for the CMOS image sensor 30 to which the present technology is applied are arranged in units of sharing pixel blocks constituting the pixel array section 41.

Specifically, in the foregoing description, each of the sharing pixel blocks includes four pixels arranged in two columns and two rows. Thus, as illustrated in FIG. 31, color filters provided in a Bayer arrangement in which four pixels in a sharing pixel block have all the same color, that is, one of R, Gr, Gb, and B, are used for the CMOS image sensor 30.

Note that, the arrangement of the color filters used for the CMOS image sensor 30 is not limited to the foregoing Bayer arrangement, but may be an arrangement other than the Bayer arrangement.

Also, in the foregoing description, each of the sharing pixel blocks includes four pixels arranged in two columns and two rows, but the configuration of each of the sharing pixel blocks may have a configuration in which a plurality of pixels share a single FD, and thus, the number of the pixels in the sharing pixel block and the pixel arrangement thereof according to the present technology are not limited to those described above.

Configuration Example of Electronic Device to which the Present Technology is Applied

Application of the present technology is not limited to application to a solid-state imaging device. That is, the present technology is applicable to overall electric devices, such as an imaging device, such as a digital still camera, a video camera, and the like, a mobile terminal device having an imaging function, a copying machine using a solid-state imaging device for an image reading section, and the like, which uses a solid-state imaging device for an image capturing section (a photoelectric conversion section). The solid-state imaging device may be embodied as a single chip, or may be embodied as a module type in which an imaging section and a signal processing section or an optical system are all packaged together and which has an imaging function.

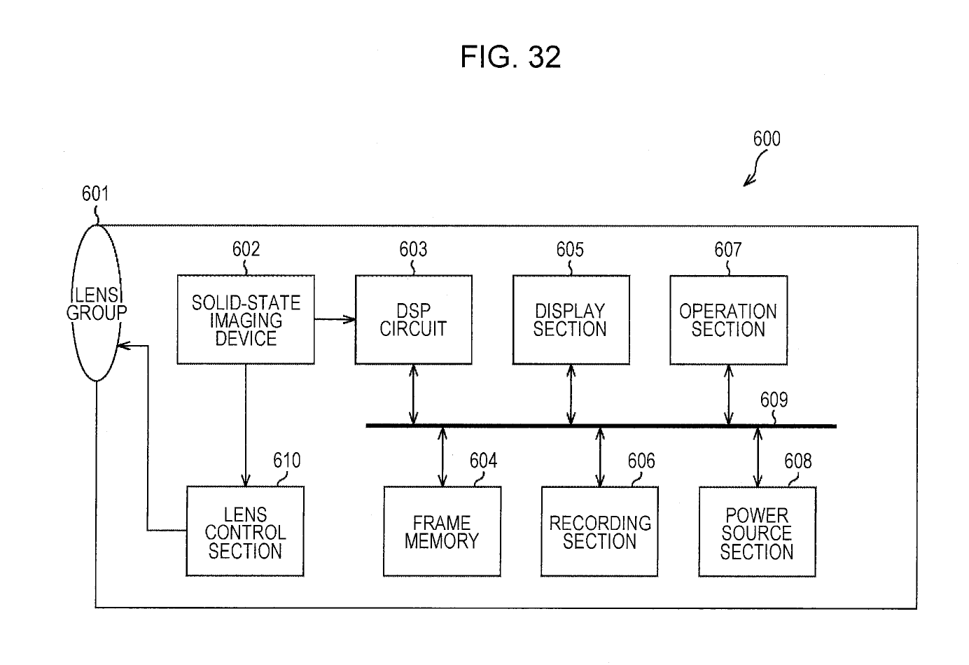

FIG. 32 is a block diagram illustrating a configuration example of an imaging device as an electronic device, to which the present technology is applied.

An imaging device 600 of FIG. 32 includes an optical section 601 including a lens group and the like, a solid-state imaging device (imaging device) 602 in which each component of the foregoing sharing pixel block is adopted, and a DSP circuit 603 serving as a camera signal processing circuit. The imaging device 600 also includes a frame memory 604, a display section 605, a recording section 606, an operation section 607, and a power source section 608. The DSP circuit 603, the frame memory 604, the display section 605, the recording section 606, the operation section 607, and the power source section 608 are connected together via a bus line 609. Furthermore, the imaging device 600 also includes a lens control section 610.

The optical section 601 captures incident light (image light) from an object to form an image on an imaging surface of a solid-state imaging device 602. The solid-state imaging device 602 converts light of an amount corresponding to the incident light formed into the image on the imaging surface by the optical section 601 to an electric signal by units of pixels and outputs the electric signal as a pixel signal. The CMOS image sensor 30 may be used as the solid-state imaging device 602.

The display section 605 includes, for example, a panel type display device such as a liquid crystal panel, an organic electroluminescence (EL) panel, and the like, and displays a moving image or a still image imaged in the solid-state imaging device 602. The recording section 606 records the moving image or the still image imaged in the solid-state imaging device 602 in a recording medium such as a digital versatile disk (DVD), and the like.

The operation section 607 gives an operation command for various functions of the imaging device 600 in accordance with an operation by a user. The power source section 608 appropriately supplies various types of power serving as an operation power source for the power source section 608, the DSP circuit 603, the frame memory 604, the display section 605, the recording section 606, and the operation section 607 to these targets of power supply.

The lens control section 610 controls driving of the optical section 601 as an optical lens and controls the F value (aperture) of the optical section 601 in accordance with the number of pixels to be driven in the sharing pixel block constituting the solid-state imaging device 602. By the lens control section 610, control of the F value in accordance with the number of pixels to be added in the sharing pixel block, which has been described with reference to FIG. 13, is realized. Note that the lens control section 610 may be provided in the solid-state imaging device 602 such that the solid-state imaging device 602 controls the F value of the optical section 601.

As described above, the CMOS image sensor 30 is used as the solid-state imaging device 602, and thus, driving of a predetermined pixel in a sharing pixel block in which pixels share a FD is controlled. Therefore, in the imaging device 600 such as a video camera, a digital still camera, and furthermore, a camera module for a mobile device such as a mobile phone and the like, photographing may be performed with more preferable sensitivity, that is, for example, the number of pixels to be added may be maximized to perform photographing with high sensitivity, the number of pixels to be added may be reduced to perform, even without using the ND filter, photographing with as low sensitivity as that achieved when the ND filter is used, and the like.

Note that embodiments of the present technology are not limited to the foregoing embodiment, but can be altered variously in a scope not departing from the spirit of the technology.

Furthermore, the present technology may have any one of configurations below.

1. A solid-state imaging device comprising:

a pixel array section including a sharing pixel block, the sharing pixel block including a plurality of pixels, each of the plurality of pixels including a photoelectric conversion region, and each of the plurality of pixels of the sharing pixel block sharing a floating diffusion region; and

a driver section configured to drive the pixel array section such that electric charges accumulated in one or more but less than all of the photoelectric conversion regions of the sharing pixel block undergo pixel addition and are read out.

2. The solid-state imaging device according to 1 above or 3 to 13 below, wherein the sharing pixel block includes four pixels arranged in a Bayer arrangement.

3. The solid-state imaging device according to 1 or 2 above, or 4 to 13 below, wherein the sharing pixel block includes four pixels each having the same color.

4. The solid-state imaging device according to 1 to 3 above or 5 to 13 below, wherein the sharing pixel block includes four pixels, and

the driver section is configured to drive the pixel array section such that electric charges accumulated in only one of the four photoelectric conversion regions of the sharing pixel block undergo pixel addition and are read out.

5. The solid-state imaging device according to 1 to 4 above or 6 to 13 below, wherein the sharing pixel block includes four pixels, and

the driver section is configured to drive the pixel array section such that electric charges accumulated in only two of the four photoelectric conversion regions of the sharing pixel block undergo pixel addition and are read out.

6. The solid-state imaging device according to 1 to 5 above or 7 to 13 below, wherein the sharing pixel block includes four pixels, and

the driver section is configured to drive the pixel array section such that electric charges accumulated in only three of the four photoelectric conversion regions of the sharing pixel block undergo pixel addition and are read out.

7. The solid-state imaging device according to 1 to 6 above or 8 to 13 below, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and

the driver section is configured to drive the pixel array section such that electric charges accumulated in the photoelectric conversion regions the first pixel and the second pixel undergo pixel addition and are read out.

8. The solid-state imaging device according to 1 to 7 above or 9 to 13 below, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and

the driver section is configured to drive the pixel array section such that electric charges accumulated in the photoelectric conversion regions the first pixel and the third pixel undergo pixel addition and are read out.

9. The solid-state imaging device according to 1 to 8 above or 10 to 13 below, wherein each pixel of the plurality of pixels includes a logic circuit, each logic circuit being configured to switch on and off a drive signal based on a control signal output by a system control section.

10. The solid-state imaging device according to 1 to 9 above or 11 to 13 below, wherein each pixel of the plurality of pixels includes a memory section and a transfer gate, the memory section being provided between the photoelectric conversion region of the pixel and the transfer gate.

11. The solid-state imaging device according to 1 to 10 above, or 12 or 13 below, wherein in each pixel, the memory section is configured to accumulate electric charges transferred from the photoelectric conversion region to the memory section by the transfer gate.

12. The solid-state imaging device according to 1 to 11 above or to 13 below, wherein when driven by a drive signal, the transfer gate transfers the accumulated electric charges from the memory section to the floating diffusion region.

13. A CMOS image sensor comprising the solid-state imaging device according to 1 to 12 above.

14. A method of driving a pixel array section, the pixel array section including a sharing pixel block, the sharing pixel block including a plurality of pixels, each of the plurality of pixels including a photoelectric conversion region, and each of the plurality of pixels of the sharing pixel block sharing a floating diffusion region, the method comprising:

driving the pixel array section such that electric charges accumulated in one or more but less than all of the photoelectric conversion regions of the sharing pixel block undergo pixel addition and are read out.

15. The method according to 14 above or 16 to 26 below, wherein the sharing pixel block includes four pixels arranged in a Bayer arrangement.

16. The method according to 14 or 15 above, or 17 to 26 below, wherein the sharing pixel block includes four pixels each having the same color.

17. The method according to 14 to 16 above or 18 to 26 below, wherein the sharing pixel block includes four pixels, and

in driving the pixel array section, the pixel array section is driven such that electric charges accumulated in only one of the four photoelectric conversion regions of the sharing pixel block undergo pixel addition and are read out.

18. The method according to 14 to 17 above or 19 to 26 below, wherein the sharing pixel block includes four pixels, and

in driving the pixel array section, the pixel array section is driven such that electric charges accumulated in only two of the four photoelectric conversion regions of the sharing pixel block undergo pixel addition and are read out.

19. The method according to 14 to 18 above or 20 to 26 below, wherein the sharing pixel block includes four pixels, and

in driving the pixel array section, the pixel array section is driven such that electric charges accumulated in only three of the four photoelectric conversion regions of the sharing pixel block undergo pixel addition and are read out.

20. The method according to 14 to 19 above or 21 to 26 below, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and

in driving the pixel array section, the pixel array section is driven such that electric charges accumulated in the photoelectric conversion regions the first pixel and the second pixel undergo pixel addition and are read out.

21. The method according to 14 to 20 above or 22 to 26 below, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and

in driving the pixel array section, the pixel array section is driven such that electric charges accumulated in the photoelectric conversion regions the first pixel and the third pixel undergo pixel addition and are read out.

22. The method according to 14 to 21 above or 23 to 26 below, wherein each pixel of the plurality of pixels includes a logic circuit, each logic circuit being configured to switch on and off a drive signal based on a control signal output by a system control section.

23. The method according to 14 to 22 above or 24 to 26 below, wherein each pixel of the plurality of pixels includes a memory section and a transfer gate, the memory section being provided between the photoelectric conversion region of the pixel and the transfer gate.

24. The method according to 14 to 23 above, or 25 or 26 below, wherein in each pixel, the memory section is configured to accumulate electric charges transferred from the photoelectric conversion region to the memory section by the transfer gate.

25. The method according to 14 to 24 above or 26 below, wherein when driven by a drive signal, the transfer gate transfers the accumulated electric charges from the memory section to the floating diffusion region.

26. A method of controlling a CMOS image sensor according to the method of 14 to 25 above.

27. A solid-state imaging device comprising:

a pixel array section including a sharing pixel block, the sharing pixel block including a plurality of pixels, each of the plurality of pixels including a photoelectric conversion region, and each of the plurality of pixels of the sharing pixel block sharing a floating diffusion region; and

means for driving the pixel array section such that electric charges accumulated in one or more but less than all of the photoelectric conversion regions of the sharing pixel block undergo pixel addition and are read out.

28. A solid-state imaging device including a pixel array section in which pixels are two-dimensionally arranged, each of the pixels including at least a photoelectric conversion section and a transfer gate configured to transfer an electric charge accumulated in the photoelectric conversion section to an electric charge voltage conversion section, and a driving control section that controls driving of the pixels, in which the electric charge voltage conversion section is shared by multiple ones of the pixels, and the driving control section controls driving of a predetermined pixel in a sharing pixel block in which the multiple ones of the pixels share the electric charge voltage conversion section.

29. The solid-state imaging device described in 28, further including a pixel driving section that switches on and off supply of a drive signal used for driving the pixels, in which the driving control section controls driving of a predetermined pixel in the sharing pixel block by controlling an operation of the pixel driving section.

30. The solid-state imaging device described in 29, in which the pixel driving section includes a driver that supplies the drive signal to each pixel in the sharing pixel block, an address decoder that selects, in the sharing pixel block, a pixel row of pixels that are to be driven, and a latch circuit that controls an operation of the driver that drives pixels of the pixel row selected by the address decoder in accordance with a writing operation performed by the driving control section.

31. The solid-state imaging device described in 30, in which the pixel driving section further includes a latch decoder circuit that decodes each output of the latch circuit and is provided for each pixel row, and the latch decoder circuit supplies an output corresponding to each output of the latch circuit to the driver that drives pixels of the pixel row selected by the address decoder.

32. The solid-state imaging device described in 28, in which each of the pixels further includes a logic circuit that switches on and off the drive signal used for driving the pixels, the driving control section controls driving a predetermined pixel in the sharing pixel block by controlling an operation of the logic circuit.

33. The solid-state imaging device described in any one of 28 to 32, in which the driving control section controls an accumulation time of the pixels in accordance with the number of pixels to be driven in the sharing pixel block.

34. The solid-state imaging device described in any one of 28 to 32, in which the driving control section controls driving of the pixels included in the sharing pixel block such that reading out of the pixels included in the sharing pixel block is performed by a plurality of separate reading operations.

35. The solid-state imaging device described in any one of 28 to 34, in which each of the pixels further includes a memory section that holds the electric charge accumulated in the photoelectric conversion section, and the transfer gate transfers the electric charge held in the memory section to the electric charge voltage conversion section.

36. A method for driving a solid-state imaging device that includes a pixel array section in which pixels are two-dimensionally arranged, each of the pixels including at least a photoelectric conversion section and a transfer gate configured to transfer an electric charge accumulated in the photoelectric conversion section to an electric charge voltage conversion section, and a driving control section that controls driving of the pixels, and that is configured such that the electric charge voltage conversion section is shared by multiple ones of the pixels, the method including controlling, by the solid-state imaging device, driving of a predetermined pixel in a sharing pixel block in which the multiple ones of the pixels share the electric charge voltage conversion section.

37. An electric device including a solid-state imaging device that includes a pixel array section in which pixels are two-dimensionally arranged, each of the pixels including at least a photoelectric conversion section and a transfer gate configured to transfer an electric charge accumulated in the photoelectric conversion section to an electric charge voltage conversion section, and a driving control section that controls driving of the pixels, and that is configured such that the electric charge voltage conversion section is shared by multiple ones of the pixels, and the driving control section controls driving of a predetermined pixel among the pixels in a sharing pixel block in which the multiple ones of the pixels share the electric charge voltage conversion section, and an optical lens that captures incident light from an object to form an image on an imaging surface of the solid-state imaging device.

38. The electric device described in 37, further including a lens control section that controls driving of the optical lens, in which the lens control section controls an F value of the optical lens in accordance with the number of pixels to be driven in the sharing pixel block.

The present disclosure contains subject matter related to that disclosed in Japanese Priority Patent Application JP 2012-218301 filed in the Japan Patent Office on Sep. 28, 2012, the entire contents of which are hereby incorporated by reference.

What is claimed is:

1. A solid-state imaging device comprising:
a pixel array section including a sharing pixel block, the sharing pixel block including a plurality of pixels, each of the plurality of pixels including a photoelectric conversion region, and each of the plurality of pixels of the sharing pixel block sharing a floating diffusion region; and
a driver section configured to drive the pixel array section such that electric charges accumulated in one or more but less than all of the photoelectric conversion regions of the sharing pixel block undergo pixel addition and are read out.

2. The solid-state imaging device according to claim 1, wherein the sharing pixel block includes four pixels arranged in a Bayer arrangement.

3. The solid-state imaging device according to claim 1, wherein the sharing pixel block includes four pixels each having the same color.

4. The solid-state imaging device according to claim 1, wherein the sharing pixel block includes four pixels, and
the driver section is configured to drive the pixel array section such that electric charges accumulated in only one of the four photoelectric conversion regions of the sharing pixel block undergo pixel addition and are read out.

5. The solid-state imaging device according to claim 1, wherein the sharing pixel block includes four pixels, and
the driver section is configured to drive the pixel array section such that electric charges accumulated in only two of the four photoelectric conversion regions of the sharing pixel block undergo pixel addition and are read out.

6. The solid-state imaging device according to claim 1, wherein the sharing pixel block includes four pixels, and
the driver section is configured to drive the pixel array section such that electric charges accumulated in only three of the four photoelectric conversion regions of the sharing pixel block undergo pixel addition and are read out.

7. The solid-state imaging device according to claim 5, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and
the driver section is configured to drive the pixel array section such that electric charges accumulated in the photoelectric conversion regions the first pixel and the second pixel undergo pixel addition and are read out.

8. The solid-state imaging device according to claim 5, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and
the driver section is configured to drive the pixel array section such that electric charges accumulated in the photoelectric conversion regions the first pixel and the third pixel undergo pixel addition and are read out.

9. The solid-state imaging device according to claim 1, wherein each pixel of the plurality of pixels includes a logic circuit, each logic circuit being configured to switch on and off a drive signal based on a control signal output by a system control section.

10. The solid-state imaging device according to claim 1, wherein each pixel of the plurality of pixels includes a memory section and a transfer gate, the memory section being provided between the photoelectric conversion region of the pixel and the transfer gate.

11. The solid-state imaging device according to claim 10, wherein in each pixel, the memory section is configured to accumulate electric charges transferred from the photoelectric conversion region to the memory section by the transfer gate.

12. The solid-state imaging device according to claim 11, wherein when driven by a drive signal, the transfer gate transfers the accumulated electric charges from the memory section to the floating diffusion region.

13. A CMOS image sensor comprising the solid-state imaging device according to claim 1.

14. A method of driving a pixel array section, the pixel array section including a sharing pixel block, the sharing pixel block including a plurality of pixels, each of the plurality of pixels including a photoelectric conversion region, and each of the plurality of pixels of the sharing pixel block sharing a floating diffusion region, the method comprising:
driving the pixel array section such that electric charges accumulated in one or more but less than all of the photoelectric conversion regions of the sharing pixel block undergo pixel addition and are read out.

15. The method according to claim 14, wherein the sharing pixel block includes four pixels arranged in a Bayer arrangement.

16. The method according to claim 14, wherein the sharing pixel block includes four pixels each having the same color.

17. The method according to claim 14, wherein the sharing pixel block includes four pixels, and
in driving the pixel array section, the pixel array section is driven such that electric charges accumulated in only one of the four photoelectric conversion regions of the sharing pixel block undergo pixel addition and are read out.

18. The method according to claim 14, wherein the sharing pixel block includes four pixels, and
in driving the pixel array section, the pixel array section is driven such that electric charges accumulated in only two of the four photoelectric conversion regions of the sharing pixel block undergo pixel addition and are read out.

19. The method according to claim 14, wherein the sharing pixel block includes four pixels, and
in driving the pixel array section, the pixel array section is driven such that electric charges accumulated in only three of the four photoelectric conversion regions of the sharing pixel block undergo pixel addition and are read out.

20. The method according to claim 18, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and
in driving the pixel array section, the pixel array section is driven such that electric charges accumulated in the photoelectric conversion regions the first pixel and the second pixel undergo pixel addition and are read out.

21. The method according to claim 18, wherein the four pixels of the sharing pixel block include a first pixel arranged in a first column and a first row, a second pixel arranged in a second column and the first row, a third pixel arranged in a the first column in a second row, and a fourth pixel arranged in the second column in the second row, and
in driving the pixel array section, the pixel array section is driven such that electric charges accumulated in the photoelectric conversion regions the first pixel and the third pixel undergo pixel addition and are read out.

22. The method according to claim 14, wherein each pixel of the plurality of pixels includes a logic circuit, each logic circuit being configured to switch on and off a drive signal based on a control signal output by a system control section.

23. The method according to claim 14, wherein each pixel of the plurality of pixels includes a memory section and a transfer gate, the memory section being provided between the photoelectric conversion region of the pixel and the transfer gate.

24. The method according to claim 23, wherein in each pixel, the memory section is configured to accumulate electric charges transferred from the photoelectric conversion region to the memory section by the transfer gate.

25. The method according to claim 24, wherein when driven by a drive signal, the transfer gate transfers the accumulated electric charges from the memory section to the floating diffusion region.

26. A method of controlling a CMOS image sensor according to the method of claim 14.

27. A solid-state imaging device comprising:
a pixel array section including a sharing pixel block, the sharing pixel block including a plurality of pixels, each of the plurality of pixels including a photoelectric conversion region, and each of the plurality of pixels of the sharing pixel block sharing a floating diffusion region; and
means for driving the pixel array section such that electric charges accumulated in one or more but less than all of the photoelectric conversion regions of the sharing pixel block undergo pixel addition and are read out.
